(19) United States
(12) Patent Application Publication
(10) Pub. No.: US 2023/0015293 A1
(43) Pub. Date: Jan. 19, 2023

(54) QUASI CO-LOCATION VARIANTS FOR SINGLE FREQUENCY NETWORK DEPLOYMENTS

(71) Applicant: QUALCOMM Incorporated, San Diego, CA (US)

(72) Inventors: Muhammad Sayed Khairy Abdelghaffar, San Jose, CA (US); Alexandros Manolakos, Escondido, CA (US); Yu Zhang, San Diego, CA (US); Peter Gaal, San Diego, CA (US)

(21) Appl. No.: 17/952,048

(22) Filed: Sep. 23, 2022

Related U.S. Application Data
(63) Continuation of application No. PCT/CN2021/072347, filed on Jan. 16, 2021.

(51) Int. Cl. H04W 16/28; H04L 5/00; H04B 7/01

(52) U.S. Cl. CPC H04W 16/28; H04L 5/0051; H04B 7/01

(57) ABSTRACT

Methods, systems, and devices for wireless communications are described. A user equipment (UE) may receive a first indication that one or more reference signals correspond to multiple beam configurations. The UE may be configurated to communicate with multiple transmission reception points. The UE may receive a second indication of a first quasi co-location (QCL) type and a second QCL type based on receiving the first indication. The first QCL type may be associated with a first beam configuration corresponding to a first transmission reception point, and the second QCL type may be associated with a second beam configuration corresponding to a second transmission reception point. The UE may determine whether the multiple transmission reception points are using a pre-compensation scheme based on the first and second QCL types. The UE may receive one or more reference signals from the multiple transmission reception points based on the determining.

### CROSS REFERENCE

The present Application for Patent is a Continuation of International Patent Application No. PCT/CN2021/072347 by ABDELGHAFFAR et al., entitled “QUASI CO-LOCATION VARIANTS FOR SINGLE FREQUENCY NETWORK DEPLOYMENTS” filed Jan. 16, 2021, assigned to the assignee hereof, and expressly incorporated by reference in its entirety herein.

### FIELD OF TECHNOLOGY

The present disclosure relates to wireless communications, including quasi co-location (QCL) variants for single frequency network (SFN) deployments.

BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). Some wireless communications system may support communications between a UE and multiple transmission reception points (TRPs). However, such systems may experience relatively inefficient or unreliable communications.

### SUMMARY

The described techniques relate to improved methods, systems, devices, and apparatuses that support quasi co-location (QCL) variants for single frequency network (SFN) deployments. Generally, the described techniques enable a network to indicate a reference signal configuration, a transmission scheme, or both to a user equipment (UE). For example, the UE may receive control signaling from one or more transmission reception points (TRPs) indicating the reference signal configuration, the transmission scheme, or both. The UE may receive, from a TRP, a first indication that one or more reference signals correspond to multiple beam configurations. As an example, a higher layer parameter may indicate the transmission schemes of tracking reference signals associated with two or more transmission configuration indicator (TCI) states (e.g., the parameter may indicate a distributed mode transmission scheme for communicating the reference signals or a partially distributed mode transmission scheme for communicating the reference signals).

Additionally or alternatively, the UE may receive a second indication of one or more QCL types. For example, the UE may identify a first QCL type associated with a first beam configuration (e.g., a first QCL type for a first set of one or more TRPs) and a second QCL type associated with a second beam configuration (e.g., a second QCL type for a second set of one or more TRPs) based on the second indication. The UE may determine that the first QCL type and the second QCL type correspond to a respective QCL variant. The UE may identify a transmission scheme based on the QCL variant (e.g., the UE may be configured to implement a pre-compensation scheme or an SFN scheme in accordance with the QCL variant). Accordingly, the UE may receive the reference signals in accordance with the determined reference signal configuration and transmission scheme, which may result in improved communications reliability (e.g., improved reception of data from multiple TRPs).

A method for wireless communications at a user equipment (UE) is described. The method may include receiving a first indication that one or more reference signals correspond to a set of multiple beam configurations, the UE configured to communicate with a set of multiple TRPs, receiving a second indication of a first QCL type and a second QCL type based on receiving the first indication, the first QCL type associated with a first beam configuration corresponding to a first TRP of the set of multiple TRPs, and the second QCL type associated with a second beam configuration corresponding to a second TRP of the set of multiple TRPs, determining whether the set of multiple TRPs is using a pre-compensation scheme based on the first QCL type and the second QCL type, and receiving the one or more reference signals from the set of multiple TRPs based on the determining.

An apparatus for wireless communications at a UE is described. The apparatus may include a processor, memory in electronic communication with the processor, and instructions stored in the memory. The instructions may be executable by the processor to cause the apparatus to receive a first indication that one or more reference signals correspond to a set of multiple beam configurations, the UE configured to communicate with a set of multiple TRPs, receive a second indication of a first QCL type and a second QCL type based on receiving the first indication, the first QCL type associated with a first beam configuration corresponding to a first TRP of the set of multiple TRPs, and the second QCL type associated with a second beam configuration corresponding to a second TRP of the set of multiple TRPs, determine whether the set of multiple TRPs is using a pre-compensation scheme based on the first QCL type and the second QCL type, and receive the one or more reference signals from the set of multiple TRPs based on the determining.

Another apparatus for wireless communications at a UE is described. The apparatus may include means for receiving a first indication that one or more reference signals correspond to a set of multiple beam configurations, the UE configured to communicate with a set of multiple TRPs, means for receiving a second indication of a first QCL type and a second QCL type based on receiving the first indication, the first QCL type associated with a first beam configuration corresponding to a first TRP of the set of multiple TRPs, and the second QCL type associated with a second beam configuration corresponding to a second TRP of the set of multiple TRPs, means for determining whether the set of multiple TRPs is using a pre-compensation scheme based on the first QCL type and the second QCL type, and means for receiving the one or more reference signals from the set of multiple TRPs based on the determining.

A non-transitory computer-readable medium storing code for wireless communications at a UE is described. The code may include instructions executable by a processor to receive a first indication that one or more reference signals correspond to a set of multiple beam configurations, the UE configured to communicate with a set of multiple TRPs, receive a second indication of a first QCL type and a second QCL type based on receiving the first indication, the first QCL type associated with a first beam configuration corresponding to a first TRP of the set of multiple TRPs, and the second QCL type associated with a second beam configuration corresponding to a second TRP of the set of multiple TRPs, determine whether the set of multiple TRPs is using a pre-compensation scheme based on the first QCL type and the second QCL type, and receive the one or more reference signals from the set of multiple TRPs based on the determining.

Some examples of the method, apparatuses, and non-transitory computer-readable medium described herein may further include operations, features, means, or instructions for determining that one or more TRPs of the set of multiple TRPs may be implementing the pre-compensation scheme based on the first QCL type being different from the second QCL type.

Some examples of the method, apparatuses, and non-transitory computer-readable medium described herein may further include operations, features, means, or instructions for receiving a first reference signal from the first TRP and a second reference signal from the second TRP and receiving a downlink message from the first TRP and the second TRP in accordance with the pre-compensation scheme based on receiving the first reference signal and the second reference signal.

Some examples of the method, apparatuses, and non-transitory computer-readable medium described herein may further include operations, features, means, or instructions for receiving a first reference signal from the first TRP and the first reference signal from the second TRP, receiving a second reference signal from the first TRP or the second TRP, and receiving a downlink message from the first TRP and the second TRP in accordance with the pre-compensation scheme based on receiving the first reference signal, the second reference signal, or both.

Some examples of the method, apparatuses, and non-transitory computer-readable medium described herein may further include operations, features, means, or instructions for receiving a first reference signal from the first TRP and a second reference signal from the second TRP and receiving a downlink message from the first TRP and the second TRP in accordance with the pre-compensation scheme based on receiving the first reference signal and the second reference signal.

Some examples of the method, apparatuses, and non-transitory computer-readable medium described herein may further include operations, features, means, or instructions for receiving a first reference signal from the first TRP and a second reference signal from the second TRP, receiving, via a set of resources, a downlink message from the first TRP based on the first reference signal, and receiving, via the set of resources, the downlink message from the second TRP based on the second reference signal.

Some examples of the method, apparatuses, and non-transitory computer-readable medium described herein may further include operations, features, means, or instructions for receiving a third reference signal from the first TRP and the second TRP, the downlink message received further based on the third reference signal.

Some examples of the method, apparatuses, and non-transitory computer-readable medium described herein may further include operations, features, means, or instructions for identifying an anchor TRP from the set of multiple TRPs based on the first beam configuration of the set of multiple beam configurations, a beam configuration with a lowest index, a third indication of the anchor TRP included in a configuration of the set of multiple beam configurations, a fourth indication in a medium access control (MAC) control element, a fifth indication to refrain from using a parameter of the beam configuration, or any combination thereof

Some examples of the method, apparatuses, and non-transitory computer-readable medium described herein may further include operations, features, means, or instructions for determining an average delay and a delay spread based on determining whether one or more TRPs of the set of multiple TRPs may be implementing the pre-compensation scheme and the one or more reference signals.

Some examples of the method, apparatuses, and non-transitory computer-readable medium described herein may further include operations, features, means, or instructions for determining a Doppler shift and a Doppler spread from a reference signal of an anchor TRP based on determining whether one or more TRPs of the set of multiple TRPs may be implementing the pre-compensation scheme and the one or more reference signals.

In some examples of the method, apparatuses, and non-transitory computer-readable medium described herein, receiving the first indication may include operations, features, means, or instructions for receiving a radio resource control message including the first indication, the first indication including a higher layer parameter.

In some examples of the method, apparatuses, and non-transitory computer-readable medium described herein, the higher layer parameter indicates a SFN downlink transmission from the set of multiple TRPs associated with the set of multiple beam configurations.

In some examples of the method, apparatuses, and non-transitory computer-readable medium described herein, the higher layer parameter may be configured as part of a physical downlink shared channel higher layer configuration, a physical downlink control channel control resource set configuration, or a combination thereof.

In some examples of the method, apparatuses, and non-transitory computer-readable medium described herein, the higher layer parameter indicates a transmission scheme associated with the reference signal configuration.

Some examples of the method, apparatuses, and non-transitory computer-readable medium described herein may further include operations, features, means, or instructions for determining a reference signal mode based on receiving the first indication, where the reference signal mode includes a distributed tracking reference signal mode or a partially distributed tracking reference signal mode.

In some examples of the method, apparatuses, and non-transitory computer-readable medium described herein, the set of multiple beam configurations include a set of multiple TCI states.

Some examples of the method, apparatuses, and non-transitory computer-readable medium described herein may further include operations, features, means, or instructions for determining one or more QCL parameters based on receiving the one or more reference signals and receiving a downlink message from the first TRP and the second TRP using the determined one or more QCL parameters.

A method for wireless communications at a base station is described. The method may include transmitting, to a UE, a first indication that one or more reference signals correspond to a set of multiple beam configurations, the UE configured to communicate with a set of multiple TRPs, determining whether to use a pre-compensation scheme to communicate with the UE using the set of multiple TRPs, transmitting a second indication of a first QCL type and a second QCL type based on determining whether the pre-compensation scheme is to be used, the first QCL type associated with a first beam configuration corresponding to a first TRP of the set of multiple TRPs, and the second QCL type associated with a second beam configuration corresponding to a second TRP of the set of multiple TRPs, and transmitting the one or more reference signals according to the first QCL type and the second QCL type.

An apparatus for wireless communications at a base station is described. The apparatus may include a processor, memory in electronic communication with the processor, and instructions stored in the memory. The instructions may be executable by the processor to cause the apparatus to transmit, to a UE, a first indication that one or more reference signals correspond to a set of multiple beam configurations, the UE configured to communicate with a set of multiple TRPs, determine whether to use a pre-compensation scheme to communicate with the UE using the set of multiple TRPs, transmit a second indication of a first QCL type and a second QCL type based on determining whether the pre-compensation scheme is to be used, the first QCL type associated with a first beam configuration corresponding to a first TRP of the set of multiple TRPs, and the second QCL type associated with a second beam configuration corresponding to a second TRP of the set of multiple TRPs, and transmit the one or more reference signals according to the first QCL type and the second QCL type.

Another apparatus for wireless communications at a base station is described. The apparatus may include means for transmitting, to a UE, a first indication that one or more reference signals correspond to a set of multiple beam configurations, the UE configured to communicate with a set of multiple TRPs, means for determining whether to use a pre-compensation scheme to communicate with the UE using the set of multiple TRPs, means for transmitting a second indication of a first QCL type and a second QCL type based on determining whether the pre-compensation scheme is to be used, the first QCL type associated with a first beam configuration corresponding to a first TRP of the set of multiple TRPs, and the second QCL type associated with a second beam configuration corresponding to a second TRP of the set of multiple TRPs, and means for transmitting the one or more reference signals according to the first QCL type and the second QCL type.

A non-transitory computer-readable medium storing code for wireless communications at a base station is described. The code may include instructions executable by a processor to transmit, to a UE, a first indication that one or more reference signals correspond to a set of multiple beam configurations, the UE configured to communicate with a set of multiple TRPs, determine whether to use a pre-compensation scheme to communicate with the UE using the set of multiple TRPs, transmit a second indication of a first QCL type and a second QCL type based on determining whether the pre-compensation scheme is to be used, the first QCL type associated with a first beam configuration corresponding to a first TRP of the set of multiple TRPs, and the second QCL type associated with a second beam configuration corresponding to a second TRP of the set of multiple TRPs, and transmit the one or more reference signals according to the first QCL type and the second QCL type.

Some examples of the method, apparatuses, and non-transitory computer-readable medium described herein may further include operations, features, means, or instructions for determining to implement the pre-compensation scheme, where the second indication indicates that the first QCL type being different from the second QCL type based on the pre-compensation scheme being different.

Some examples of the method, apparatuses, and non-transitory computer-readable medium described herein may further include operations, features, means, or instructions for transmitting a first reference signal from the first TRP different from a second reference signal from the second TRP and transmitting a downlink message in accordance with the pre-compensation scheme based on transmitting the first reference signal.

Some examples of the method, apparatuses, and non-transitory computer-readable medium described herein may further include operations, features, means, or instructions for transmitting a first reference signal and transmitting a downlink message in accordance with the pre-compensation scheme based on transmitting the first reference signal.

Some examples of the method, apparatuses, and non-transitory computer-readable medium described herein may further include operations, features, means, or instructions for transmitting a first reference signal different from a second reference signal from the second TRP and transmitting a downlink message in accordance with the pre-compensation scheme based on transmitting the first reference signal and the second reference signal.

Some examples of the method, apparatuses, and non-transitory computer-readable medium described herein may further include operations, features, means, or instructions for transmitting a first reference signal from the first TRP different from a second reference signal from the second TRP and transmitting, via a set of resources, a downlink message to the UE based on transmitting the first reference signal.

In some examples of the method, apparatuses, and non-transitory computer-readable medium described herein, and the method, apparatuses, and non-transitory computer-readable medium may include further operations, features, means, or instructions for transmitting, to the UE, a third indication of the anchor TRP included in a configuration of the set of multiple beam configurations, a fourth indication in a medium access control (MAC) control element command message, a fifth indication to refrain from using a parameter of a beam configuration, or any combination thereof.

### BRIEF DESCRIPTION OF THE DRAWINGS

FIG. 1 illustrates an example of a wireless communications system that supports quasi co-location (QCL) variants for single frequency network (SFN) deployments in accordance with aspects of the present disclosure.

FIG. 2 illustrates an example of a wireless communications system that supports QCL variants for SFN deployments in accordance with aspects of the present disclosure.

FIGS. 3A and 3B illustrate examples of wireless communications systems that supports QCL variants for SFN deployments in accordance with aspects of the present disclosure.

FIGS. 4-6 illustrate examples of process flows that support QCL variants for SFN deployments in accordance with aspects of the present disclosure.

FIGS. 7 and 8 show block diagrams of devices that support QCL variants for SFN deployments in accordance with aspects of the present disclosure.

FIG. 9 shows a block diagram of a communications manager that supports QCL variants for SFN deployments in accordance with aspects of the present disclosure.

FIG. 10 shows a diagram of a system including a device that supports QCL variants for SFN deployments in accordance with aspects of the present disclosure.

FIGS. 11 and 12 show block diagrams of devices that support QCL variants for SFN deployments in accordance with aspects of the present disclosure.

FIG. 13 shows a block diagram of a communications manager that supports QCL variants for SFN deployments in accordance with aspects of the present disclosure.

FIG. 14 shows a diagram of a system including a device that supports QCL variants for SFN deployments in accordance with aspects of the present disclosure.

FIGS. 15 through 18 show flowcharts illustrating methods that support QCL variants for SFN deployments in accordance with aspects of the present disclosure.

### DETAILED DESCRIPTION

In some wireless communications systems, a user equipment (UE) may support communications with multiple transmission reception points (TRPs) (e.g., in a multi-TRP configuration). For example, the wireless communications system may include a cell associated with multiple TRPs, in which a UE may communicate with the cell by more than one TRP. Additionally or alternatively, the wireless communications system may include a cell associated with a remote radio head (RRH) or multiple RRHs, where the UE may communicate with a TRP by more than one RRH. For example, the UE may receive single frequency network (SFN) transmissions from the multiple TRPs (or multiple RRHs). That is, the UE may receive multiple instances of a transmission from each of the multiple TRPs and utilize them to decode a single downlink transmission. Additionally, the UE may be moving with respect to one or more of the TRPs. Thus, communications between the UE and each of the TRPs may by associated with Doppler shifts or Doppler spreads. In some cases, the Doppler effects on communications between a UE and the multiple TRPs may not be consistent from one TRP to another TRP. That is, communications between the UE and a first TRP may experience a larger Doppler shift than communications between the UE and a second TRP. In some cases, the variable Doppler effects on communications between the UE and the multiple TRPs may degrade communications (e.g. decrease a reliability of the communications) between the UE and the multiple TRPs.

In accordance with the techniques described herein, a wireless communications system may support quasi co-location (QCL) variants for single frequency network (SFN) deployments. One or more TRPs in communication with a UE may indicate a reference signal configuration, a transmission scheme, or both to the UE. For example, a TRP may transmit control signaling (e.g., radio resource control (RRC) signaling) including a first indication that one or more reference signals correspond to multiple beam configurations (e.g., multiple transmission configuration indicator (TCI) states). In some examples, the first indication may include a parameter indicating that the reference signal configuration is a distributed mode or a partially distributed mode. If the reference signal configuration is the distributed mode, each TRP of multiple TRPs may send individual reference signals (e.g., a first group of one or more TRPs may send a first reference signal and a second group of one or more TRPs may send a second reference signal). If the reference signal configuration is the partially distributed mode, multiple TRPs may transmit a same reference signal in an SFN manner in addition or alternative to one or more TRPs transmitting a second reference signal different than the first reference signal. The reference signals may be examples of a tracking reference signal (TRS), a synchronization signal block (SSB) transmission, a channel state information reference signal (CSI-RS), or any combination thereof. The UE may estimate aspects of a channel using the reference signals as described herein.

In some examples, the UE may receive a second indication from the one or more TRPs. The second indication may indicate one or more QCL types associated with one or more groups of TRPs. As an example, the UE may identify a first QCL type associated with a first beam configuration based on the second indication. For instance, the UE may be configured with a first TCI state for a first set of one or more TRPs and the UE may determine a first QCL type associated with the first TCI state. Additionally or alternatively, the UE may identify a second QCL type associated with a second beam configuration. For example, the UE may be configured with a second TCI state for a second set of one or more TRPs and the UE may determine a second QCL type associated with a second TCI state. In some cases, a QCL type may be associated with a set of QCL parameters (e.g., an average delay, a delay spread, a Doppler shift, a Doppler spread, a spatial filter parameter, or any combination thereof).

The UE may determine one or more configurations, schemes, anchor TRPs, parameters, or any combination thereof based at least in part on receiving the first indication and the second indication. For example, the UE may determine the reference signal configuration (e.g., a distributed mode or partially distributed mode) based on the first indication. In some examples, the UE may determine whether the reference signal configuration includes a TRP-specific configuration (e.g., reference signals may be transmitted on a per-TRP basis or per group of TRPs), which may be referred to as a distributed mode. In some other examples, the UE may determine whether the reference signal configuration includes a SFN configuration (e.g., a same reference signal may be transmitted by multiple TRPs and a different reference signal may be transmitted by at least a subset of the multiple TRPs), which may be referred to as a partial distributed mode (which may be referred to as a scheme, technique, procedure, etc., herein) or a backwards compatible mode (which may be referred to as a scheme, technique, procedure, etc., herein). Additionally or alternatively, the UE may determine the transmission scheme based on identifying a first QCL type and a second QCL type. For example, the UE may determine a respective QCL variant associated with the first QCL type and the second QCL type. The QCL variant may correspond to a transmission scheme. For example, the UE may determine whether the transmission scheme includes a pre-compensation scheme or an SFN scheme based on the QCL variant.

In some examples, the UE may identify an anchor TRP of the multiple TRPs. For example, the UE may determine that a TRP with a TCI state including a Doppler shift parameter is the anchor TRP. In some examples, the UE may determine that the anchor TRP is the TRP associated with a first TCI state or a TCI state with a lowest state identifier (ID). Additionally or alternatively, the UE may identify the anchor TRP based on a corresponding configuration of a TCI state having an indication (e.g., a flag), or the UE may receive a medium access control (MAC) control element (CE) command indicating the anchor TRP. In some cases, the UE may receive an indication to ignore a QCL parameter of a TCI state and the UE may determine that a different TCI state is associated with the anchor TRP.

In some examples, the UE may determine one or more QCL parameters based on receiving the reference signals in accordance with a transmission scheme and reference signal configuration. For example, the UE may extract an average delay, a delay spread, a Doppler shift, a Doppler spread, or any combination thereof from one or more tracking reference signals.

Various aspects of the subject matter described herein may be implemented to realize one or more of the following potential advantages. The techniques employed by the described devices may provide benefits and enhancements to the operation of the devices. For example, operations performed by the devices may provide improvements to reliability and efficiency in receiving and decoding communications from multiple TRPs. For example, a network (e.g., base stations, TRPs) may be enabled to configure or indicate various transmission schemes and reference signal configurations to a UE, which may result in improved reference signaling and reduce the likelihood of decoding errors. Such techniques may be useful in various different situations, such as in cases where a UE is traveling at a relatively high speed in relation to one or more TRPs (e.g., in high speed train (HST) scenarios), and received signals may have relatively large Doppler shifts. The described techniques may thus include features for improvements to reliability in communications and enhanced communications efficiency, among other advantages.

Aspects of the disclosure are initially described in the context of wireless communications systems and process flows. Aspects of the disclosure are further illustrated by and described with reference to apparatus diagrams, system diagrams, and flowcharts that relate to QCL variants for SFN deployments.

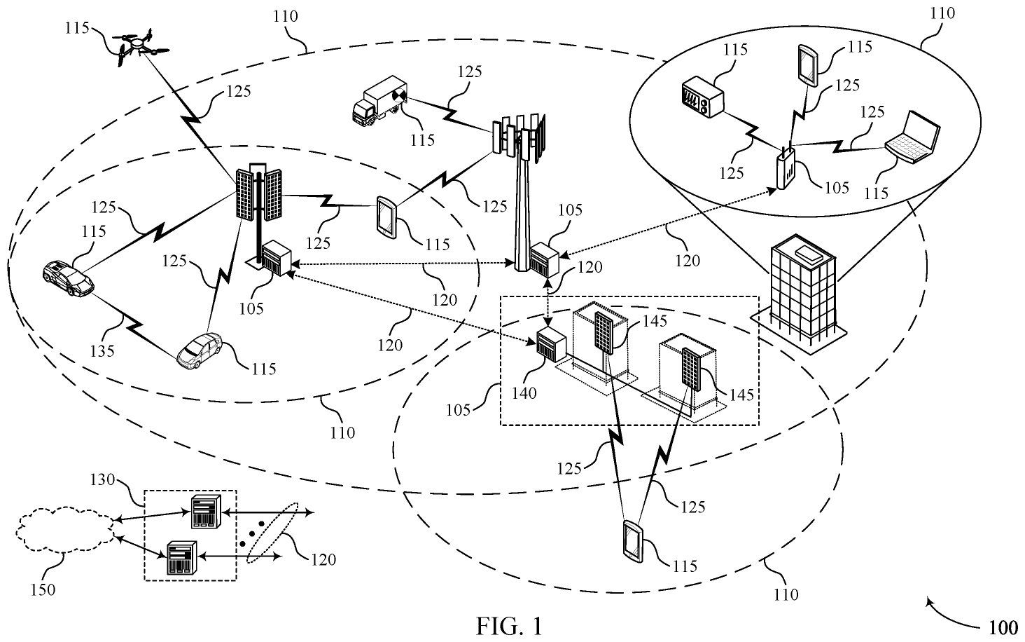

FIG. 1 illustrates an example of a wireless communications system 100 that supports QCL variants for SFN deployments in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The wireless communications systems 100 may support a multi-TRP configuration. For example, a UE 115 may receive downlink transmissions (e.g., via a physical downlink shared channel (PDSCH) or a physical downlink control channel (PDCCH)) from multiple TRPs. Thus, the UE 115 may utilize one or more multiplexing schemes (e.g., spatial multiplexing) to receive and decode each of the downlink transmissions from the multiple TRPs. Additionally, the UE 115 may decode each of the downlink transmissions according to a TCI state (e.g., a beam configuration) associated with the downlink transmission. In some cases, each TCI state may correspond to a QCL type (e.g., a QCL relationship). For example, the UE 115 may assume that certain channel estimations may be similar for transmissions associated with a same TCI state (e.g., due to the QCL relationship). In some cases of the multi-TRP configuration, a single TRP may transmit downlink control information (DCI) indicating multiple TCI states each associated with a downlink transmission from one of the multiple TRPs (e.g., when the multiple TRPs have an ideal backhaul communication link). For example, a first TRP may transmit DCI indicating a first TCI state for a subsequent downlink transmission by the first TRP. In this example, the second TRP may not transmit DCI to the UE 115. That is, although the UE 115 is in communication with multiple TRPs, the UE 115 may only receive DCI from the first TRP.

In some other cases of a multi-TRP configuration, the UE 115 may receive DCI from each of the multiple TRPs. In such cases, the UE 115 may decode downlink transmissions according to a TCI state indicated by the DCI transmitted by the same TRP. For example, the UE 115 may decode a downlink transmission from a first TRP according to a TCI state indicated by the first TRP within DCI. Additionally, the UE 115 may decode a downlink transmission from a second TRP according to a TCI state indicated by the second TRP within DCI. In some cases, a UE 115 may identify which TRP a TCI state is associated with based on a control resource set (e.g., a CORESET) associated with the DCI indicating the TCI state. That is, the UE 115 may receive the DCI from a TRP by a CORESET in a physical control channel (e.g., a PDCCH). The CORESET may be associated with a CORESET index (e.g., a CORESETPoolIndex) that indicates one or more TRPs. Thus, based on the CORESET associated with the received DCI, the UE 115 may identify a TRP or group of TRPs that transmitted the DCI. In turn, the UE 115 may identify a TRP or group of TRPs associated with the TCI state indicated by the DCI.

Additionally, a UE 115 in communication with more than one TRP may receive SFN transmissions from each of the TRPs. That is, more than one TRP may transmit a same downlink communication (e.g., a PDSCH transmission) to the UE 115 over a same set of frequency resources. Thus, the UE 115 may receive a same downlink transmission from more than one TRP. In some cases, this may increase a spatial diversity of the downlink transmission and may improve a reliability of the downlink transmission when compared to a downlink transmission that is transmitted by a single TRP. In some cases, an SFN transmission may be associated with a single TCI state. That is, the UE 115 may receive the downlink transmission based on a single TCI state and each TRP may transmit the downlink transmission according to the single TCI state. In some other cases, an SFN transmission may be associated with more than one TCI state. That is, the UE 115 may receive the downlink transmission based on more than one TCI state. Additionally, each TRP may transmit the downlink transmission based on the more than one TCI state.

To properly interpret received transmissions from one or more TRPs, the UE 115 may determine one or more properties of a channel over which the one or more transmissions were made. For example, the UE 115 may estimate aspects of a radio channel based on one or more reference signals transmitted over the channel between the TRP and the UE 115. The channel estimations may assist the UE 115 in interpreting received downlink transmissions and relevant channel state information (CSI), among other examples. In some cases, multiple TRPs may transmit reference signals to the UE 115 for channel estimation that are SFN reference signals. Thus, the UE 115 may perform channel estimations based on the SFN channel associated with multiple reference signal transmissions from different TRPs. In some cases, the UE 115 may be moving with respect to one or more of the TRPs, resulting in a Doppler effect impacting one or more of the reference signal transmissions. Additionally, a relative movement between the UE 115 and a first TRP may be different than a relative movement between the UE 115 and a second TRP. Thus, performing a single channel estimation on the SFN channel may not reliably estimate the Doppler effects on the channel.

Additionally or alternatively, the UE 115 may receive reference signals from the multiple TRPs that are not SFN reference signal transmissions. Thus, the UE 115 may perform a channel estimation (e.g., to estimate one or more Doppler metrics associated with the channel) on each channel associated with a single TRP. In some cases, this may enable the UE 115 to more reliably estimate the Doppler effects on the channels (e.g., when compared to estimating the Doppler effects on an SFN channel).

In some examples, the network (e.g., the multiple TRPs) may indicate a reference signal configuration, a transmission scheme, or both to a UE 115. For example, the UE 115 may receive control signaling from one or more TRPs indicating the reference signal configuration, the transmission scheme, or both. The UE 115 may receive, from a TRP, a first indication that one or more reference signals correspond to multiple beam configurations (e.g., multiple TCI states). As an example, the first indication may include a higher layer parameter indicating the transmission schemes of tracking reference signals associated with two or more TCI states (e.g., the parameter may indicate a distributed mode transmission scheme for communicating the reference signals or a partially distributed mode transmission scheme for communicating the reference signals).

Additionally or alternatively, the UE 115 may receive a second indication of one or more QCL types. For example, the UE 115 may identify a first QCL type associated with a first beam configuration (e.g., a first QCL type for a first set of one or more TRPs) and a second QCL type associated with a second beam configuration (e.g., a second QCL type for a second set of one or more TRPs) based on the second indication. The UE 115 may determine that the first QCL type and the second QCL type correspond to a respective QCL variant. The UE may identify a transmission scheme based on the QCL variant (e.g., the UE 115 may be configured to implement a pre-compensation scheme or an SFN scheme in accordance with the QCL variant). Accordingly, the UE 115 may receive the reference signals in accordance with the determined reference signal configuration and transmission scheme, which may result in improved communications reliability (e.g., improved reception of data from multiple TRPs).

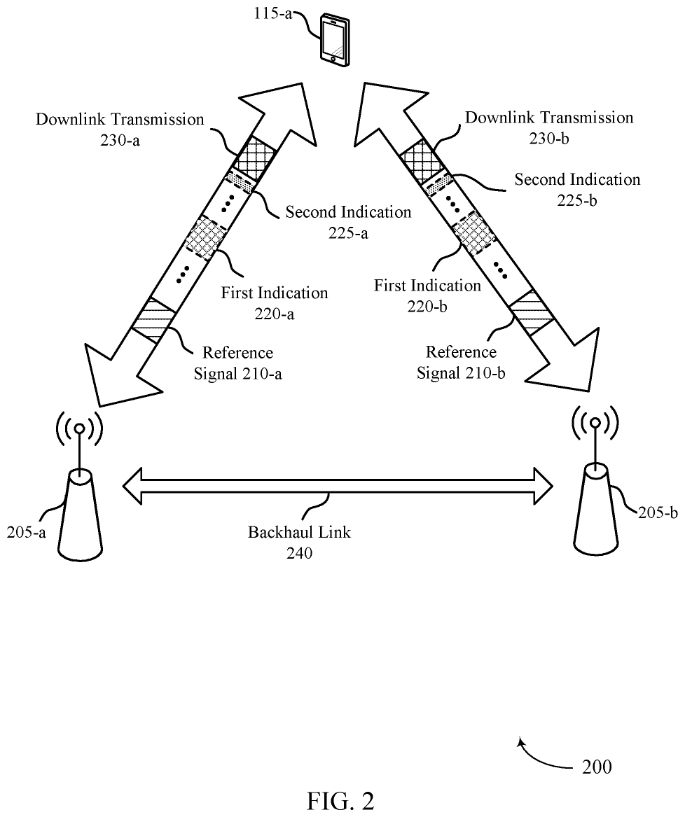

FIG. 2 illustrates an example of a wireless communications system 200 that supports QCL variants for SFN deployments in accordance with aspects of the present disclosure. In some examples, wireless communications system 200 may implement aspects of wireless communications system 100. The wireless communications system 200 may include a UE 115-a, which may be an example of a UE 115 as described with reference to FIG. 1. Additionally, the wireless communications system 200 may include TRPs 205, which may be examples of access network transmission entities 145, base stations 105, or a combination thereof, as described with reference to FIG. 1. In wireless communications system 200, the UE 115-a may be configured to communicate with multiple TRPs 205 (e.g., TRP 205-a and TRP 205-b). In some examples, the operations described in the wireless communications system 200 may be performed at other devices or in different orders.

The UE 115-a may be in communication with a serving cell by the first TRP 205-a and the second TRP 205-b. In some cases, the UE 115-a may additionally be in communication with additional TRPs 205 associated with the serving cell or TRPs 205 outside of the serving cell. The UE 115-a may receive one or more indications (e.g., via RRC signaling, MAC-CE signaling, DCI transmissions, or combinations thereof) of active TCI states associated with receiving downlink transmissions from the TRP 205-a and the TRP 205-b. For example, the TRP 205-a may transmit DCI to the UE 115-a indicating a first TCI state for communications between the TRP 205-a and the UE 115-a. Additionally, the TRP 205-b may transmit DCI to the UE 115-a indicating a second TCI state (e.g., different from the first TCI state) for communications between the TRP 205-b and the UE 115-a. In another example, one of the TRPs 205 may transmit DCI to the UE 115-a that indicates the first TCI state for communications between the UE 115-a and the TRP 205-a and the second TCI state for communications between the UE 115-a and the TRP 205-b.

The TRPs 205 communicating with the UE 115-a may configure the UE 115-a with a reference signal configuration, a transmission scheme, or both. For example, one or more of the TRPs 205 may transmit control signaling (e.g., RRC signaling, DCI messages, MAC-CE signaling, or any combination thereof) including a first indication 220, a second indication 225, or both. That is, the UE 115-a may receive a first indication 220-a from the TRP 205-a, a first indication 220-b from the TRP 205-b, a second indication 225-a from the TRP 205-a, a second indication 225-b from the TRP 205-b, or any combination thereof.

In some examples, the first indication may be an example of a parameter (e.g., a higher layer parameter in RRC signaling) that indicates the transmission schemes of reference signals with two or more beam configurations (e.g., a parameter “SFN_TRS_mode” may indicate a transmission scheme for tracking reference signals associated with multiple TCI states). For example, the first indication may be a flag in control signaling indicating that downlink communications (e.g., PDSCH messages, or PDCCH messages, or both) associated with multiple TCI states may correspond to SFN schemes and one or more a demodulation reference signal (DMRS) ports may be associated with two (or more) TCI states. In some examples, such a flag may be an example of an RRC flag (e.g., “SFN TRS mode”) and may be configured via an information element (e.g., “PDSCH config”) for SFN PDSCH communications with multiple TCI states. Additionally or alternatively, the RRC flag may be configured at a CORESET information element for SFN PDCCH communications with multiple TCI states. Stated alternatively, the higher layer parameter (or parameters) may be configured as part of a PDSCH higher layer configuration or as part of a PDCCH CORESET or a combination thereof. In some examples, the higher layer parameter may indicate SFN downlink transmission from multi-TRPs with multiple TCI states (e.g., the higher layer parameter may indicate a transmission scheme, a reference signal configuration, etc., as described herein). As an illustrative example, the higher layer parameter may indicate the transmission mode of tracking reference signals in either distributed or partially distributed modes.

In some examples, the reference signal mode (e.g., tracking reference signal mode) or configuration may be set to a distributed mode, where each TRP 205 may send individual reference signals (e.g., the TRP 205-a may send a first reference signal 210-a and the TRP 205-b may send a second reference signal 210-b that is different than the first reference signal 210-a or configured separately from the first reference signal 210-a). Such a distributed mode may be applicable to groups of TRPs 205 (e.g., multiple TRPs of a first group may send a first reference signal 210-a and multiple TRPs of a second group may send a different reference signal 210-b). In some other examples, the reference signal mode may be set to a partial distributed mode where one reference signal 210 is sent in an SFN manner while a second reference signal 210 is sent from one of the TRPs 205 (or group of TRPs 205). As an illustrative example, the TRP 205-a may send the reference signal 210-a that is the same as the reference signal 210-b sent from the TRP 205-b, and the TRP 205-a may additionally send another reference signal 210 that is different than the reference signal 210-b.

In some examples, the UE 115-a may receive a second indication 225 from one or more of the TRPs 205 (e.g., additionally or alternatively to the first indication 220). For example, the UE 115-a may receive a second indication 225-a indicating a QCL type associated with the TRP 205-a and the UE 115-a may receive a second indication 225-b indicating a QCL type associated with the TRP 205-b. In some examples, the UE 115-a may receive the second indication 225-a indicating QCL types for multiple TRPs 205 (e.g., a group of TRPs 205 or a respective QCL type for each of multiple TRPs 205). In some examples, a first indication 220 and a second indication 225 may be included in a same signal or message, or the indications may be transmitted separately via different signaling or messages.

The UE 115-a may determine one or more QCL types based on receiving the second indication 225-a. For example, the UE 115-a may identify a first QCL type associated with a first beam configuration (e.g., the first QCL type may be indicated via a first TCI state for communications with the TRP 205-a). The UE 115-a may identify a second QCL type associated with a second beam configuration (e.g., the second QCL type may be indicated via a second TCI state for communications with the TRP 205-b). In some cases, the first QCL type may be applied for a first group of TRPs and the second QCL type may be applied for a second group of TRPs, although any quantity of TRPs and QCL types may be implemented.

The QCL types may each correspond to one or more QCL parameters, such as an average delay, a delay spread, a Doppler shift, a Doppler spread, a spatial filter parameter, or any combination thereof, among other examples of QCL parameters. In some examples, a QCL type may correspond to a spatial filter parameter and may be referred to as a QCL type D. In some examples, a QCL type D may be implemented in some frequency ranges such as a frequency range 2 (FR2) corresponding to deployments in 24-52.6 GHz ranges. Additionally or alternatively, a QCL type may correspond to a Doppler shift, a Doppler spread, an average delay, a delay spread, or any combination thereof, among other examples of QCL parameters. In some examples, such QCL types may be referred to as a QCL type A (e.g., a QCL type associated with a Doppler shift, a Doppler spread, an average delay, and a delay spread), a QCL type B (e.g., a QCL type associated with a Doppler shift and a Doppler spread), a QCL type C (e.g., a QCL type associated with a Doppler shift and an average delay), or any combination thereof, among other examples of QCL types (e.g., a QCL type associated with a delay spread and an average delay, a QCL type associated with a delay spread, or other examples of QCL types).

The UE 115-a may receive the reference signals 210 in accordance with a QCL type. For example, the UE 115-a may receive DMRSs from the TRP 205-a that are QCL with the reference signal 210-a (e.g., a TRS), which may enable the UE 115-a to determine one or more QCL parameters in accordance with a configured QCL type and the UE 115-a may apply such parameters to the various antenna ports in the wireless communications system.

For example, two signals sent from a same antenna port of the TRP 205-a may experience a same radio channel. Signals sent from different antenna ports may experience different channel conditions. In some cases, if the different antenna ports are quasi co-located, the radio channels may have common properties or parameters. For example, QCL antenna ports may experience the same or similar Doppler spreads, Doppler shifts, average delay, delay spread, or spatial filter parameters, among other examples of QCL parameters. A Doppler shift may be an example of a shift in frequency of a radio signal relative to a motion of the UE 115-a (e.g., if the UE 115-a is in a high speed train deployment, the UE 115-a may experience a relatively high Doppler shift). A Doppler spread may be referred to as a fading rate (e.g., a difference between a signal frequency at the transmitter device and receiver device with respect to time may be referred to as a Doppler spread). An average delay may be an example of the average time for the UE 115-a to receive a signal from multiple paths (e.g., due to reflection and propagation of the signal paths in the environment) between the UE 115-a and a respective TRP 205. The delay spread may be an example of a difference between the time or arrival for an earliest path (e.g., a line of sight path) and a latest path. The spatial filter parameter may be an example of beamforming properties of a downlink received signal (e.g., an angle of arrival, an average angle of arrival, a dominant angle of arrival, and the like), and may also be referred to as a spatial receiver parameter.

Such QCL parameters may enable the UE 115-a or the TRPs 205 to estimate channel conditions (e.g., frequency offset error estimation and synchronization procedures). As an example, the UE 115-a may determine QCL parameters associated with a first antenna port via a first reference signal and apply the QCL parameters of the QCL type to other antenna ports that are quasi co-located with the first antenna port. As one illustrative example, the UE 115-a may receive the reference signal 210-a (e.g., a TRS, a DMRS, etc.) from a first antenna port and determine one or more QCL parameters based on receiving the reference signal 210-a. The UE 115-a may estimate channel conditions based on receiving the reference signals 210 as described herein. The UE 115-a may apply the QCL parameters to another antenna port, such as an antenna used to transmit downlink information (e.g., PDCCH messages, PDSCH messages, etc.) or other reference signals.

The UE 115-a may determine a QCL variant based on identifying the QCL types based on the second indication(s) 225. For example, the UE 115-a may be configured with a look up table to determine the QCL variant that corresponds to the first QCL type of a first TCI state and a second QCL type of a second TCI state. A first QCL variant (e.g., Variant A) may correspond to a first QCL type associated with an average delay and a delay spread and a second QCL type associated with an average delay, a delay spread, a Doppler shift, and a Doppler spread (e.g., a QCL type A). A second QCL variant (e.g., Variant B) may correspond to a first QCL type associated with an average delay and a delay spread and a second QCL type associated with a Doppler shift and a Doppler spread (e.g., a QCL type B). A third QCL variant (e.g., Variant C) may correspond to a first QCL type associated with a delay spread and a second QCL type associated with an average delay, a delay spread, a Doppler shift, and a Doppler spread (e.g., a QCL type A). A fourth QCL variant (e.g., Variant E) may correspond to a first QCL type and a second QCL type being a same QCL type. For example, the first QCL type and the second QCL type may be examples of a QCL type associated with an average delay, a delay spread, a Doppler shift, and a Doppler spread (e.g., a QCL type A). Although four variants are described herein, it is to be understood that any combination of QCL types and QCL parameters may be used for such variants or other examples of variants.

The UE 115-a may determine a transmission scheme based on identifying a QCL variant using the QCL types of various TCI states. For example, the QCL types of the TCI states may indicate whether the transmission scheme in the wireless communications system is a pre-compensation scheme (e.g., whether transmissions are Doppler-shift pre-compensated) or another transmission scheme. In a pre-compensation scheme, a network (e.g., the TRPs 205) may pre-compensate a downlink signal from one or more TRPs 205 such that the UE 115-a may experience relatively small Doppler spectrum of the downlink signal. In some examples, the network may perform the pre-compensation based on an uplink signal (e.g., sounding reference signals (SRSs)) or the UE 115-a may report estimated parameters (e.g., Doppler shifts) and the network may perform the pre-compensation based on the report. Accordingly, the devices of the wireless communications system 200 may identify a QCL variant and a corresponding transmission scheme.

As an illustrative example, if the higher layer parameter is configured (e.g., via the first indications 220-a and/or 220-b) at the UE 115-a and the QCL types of both TCI states refer to a same type (e.g., variant E in which both QCL types are QCL type A), then the UE 115-a may determine that the transmission scheme is not pre-compensated. In some such examples, the higher layer parameter may indicate the mode or scheme of the reference signal transmission (e.g., the parameter may indicate a distributed mode or partially distributed mode for transmission of tracking reference signals, as an example).

As another illustrative example, the QCL types of the TCI states may be different (e.g., one or more of the QCL types may be different than Type A and the resulting QCL variant may be different than variant E, such as variant A, B, or C). In such examples, the UE 115-a, the TRPs 205, or a combination thereof may determine that the transmission scheme is pre-compensated (e.g., the TRPs 205 and/or the UE 115-a may perform Doppler shift pre-compensation operations for downlink transmissions 230 or uplink transmissions). In some such examples, a second QCL type (e.g., the QCL type associated with a second TCI state of the TRP 205-b) may indicate a reference signal configuration (e.g., a TRS mode). For instance, if the second QCL type is a QCL type B the devices of the wireless communications system 200 may determine to implement a partially distributed (i.e., backward compatible) TRS mode. Alternatively, if the second QCL type is a QCL type A the devices may implement a distributed TRS mode.

In some examples, the UE 115-a may identify an anchor TRP 205 of the multiple TRPs 205. For example, the UE 115-a may perform frequency tracking techniques (e.g., the UE 115-a may run frequency tracking loops) using a TRS of the anchor TRP 205. In some examples, the UE 115-a may determine that the transmission scheme is a pre-compensation scheme (e.g., based on a QCL variant as described herein). In such examples, the UE 115-a may determine that the TRP 205 associated with a QCL type having a Doppler shift parameter is the anchor TRP 205 (i.e., primary TRP 205), although other QCL parameters or QCL types may be used.

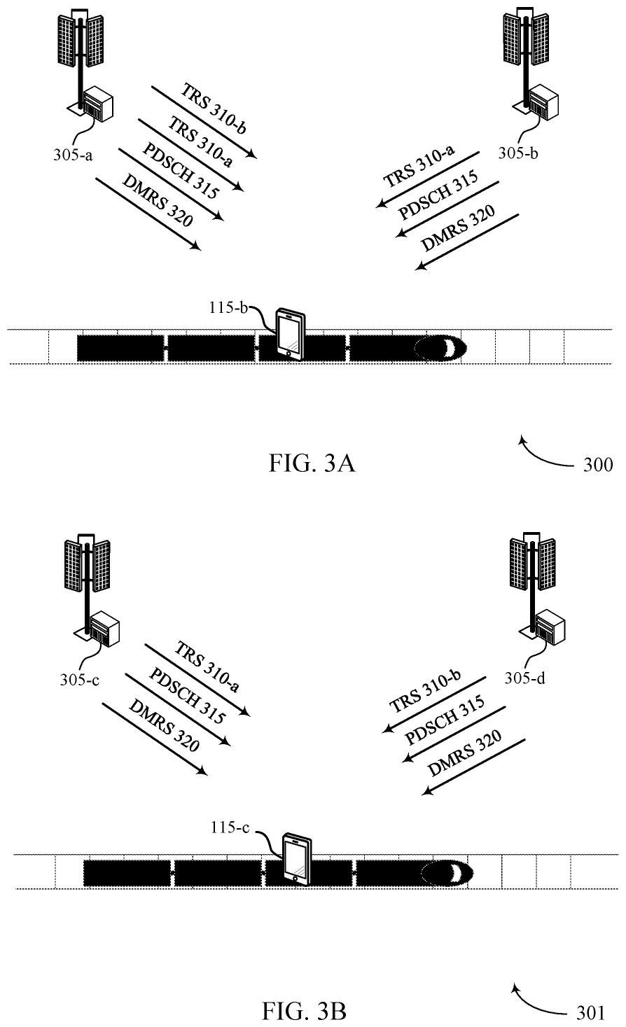

In some other examples, the UE 115-a may determine that the transmission scheme is a scheme different than the pre-compensation scheme (e.g., an SFN scheme 1 as described herein with reference to FIG. 3B). For example, the transmission scheme may not implement pre-compensation (e.g., TRSs may be transmitted on a per-TRP basis or a non-SFN manner while DMRS and downlink transmissions 230 may be transmitted in an SFN manner from the TRPs 205). In such examples, the QCL types may have properties (e.g., parameters) that both include the Doppler shift parameter. Accordingly, the UE 115-a may identify the anchor TRP 205 via another indication or rule. In some examples, the UE 115-a may determine that the TRP 205 associated with a first TCI state or a TCI state with a lowest state ID is the anchor TRP 205. Additionally or alternatively, the UE 115-a may identify the anchor TRP 205 based on a corresponding configuration of a TCI state having an indication (e.g., a flag) of the anchor TRP 205 (e.g., a configuration sent by the TRP 205-a may include a flag with a value indicating that the TRP 205-a is the anchor TRP). In some examples, the UE 115-a may receive a MAC-CE command indicating the anchor TRP (e.g., a bit of 0 or 1 may indicate whether the TCI state 1 or the TCI state 2 is the primary TRP 205). In some cases, the UE may receive an indication to ignore a QCL parameter of a TCI state (e.g., the UE 115-a may receive a message from one or more TRPs 205 indicating that the UE 115-a ignore the Doppler shift parameter of a TCI state) and the UE 115-a may determine that the other TCI state is associated with the anchor TRP 205.

The UE 115-a may perform one or more operations based on the transmission scheme, reference signal configuration, or both. For example, the UE 115-a may determine one or more QCL parameters, channel delay properties, Doppler shifts and spreads, or any combination thereof based on the determined transmission scheme and reference signal configuration.

In some examples, the UE 115-a may determine an average delay and a delay spread. As an illustrative example, the UE 115-a may determine that a transmission scheme is a Doppler-shift pre-compensated transmission scheme. In some cases, the UE 115-a may determine that the reference signal configuration is a distributed mode. In such examples, the UE 115-a may extract an average delay and delay spread based on a combined channel impulse response (CIR) (e.g., a model of a signal going through a channel) from both reference signal 210-a and reference signal 210-b. Stated alternatively, the UE 115-a may combine signal properties of the reference signal 210-a with signal properties of the reference signal 210-b to obtain the combined CIR and determine the average delay and delay spread based on the combined CIR. In some other cases, the UE 115-a may determine that the reference signal configuration is a partial distributed mode. In such examples, the UE may extract the average delay and delay spread based on the reference signal 210 that corresponds to QCL properties of average delay and delay spread (e.g., the reference signal 210 associated with a QCL type E).

As another illustrative example, the UE 115-a may determine that the transmission scheme does not used a Doppler-shift pre-compensation scheme (e.g., an enhanced SFN scheme without pre-compensation). In some such cases, the UE 115-a may determine that the reference signal configuration is a distributed mode. The UE 115-a may extract an average delay and delay spread based on a combined CIR from both reference signal 210-a and reference signal 210-b. Stated alternatively, the UE 115-a may combine signal properties of the reference signal 210-a with signal properties of the reference signal 210-b to obtain the combined CIR and determine the average delay and delay spread based on the combined CIR. In some other cases, the UE 115-a may determine that the reference signal configuration is a partial distributed mode. In such examples, for a DMRS CE, the UE 115-a may extract the average delay and delay spread based on the reference signal 210 (e.g., TRS) that corresponds to QCL properties of average delay and delay spread (e.g., the reference signal 210 associated with a QCL type E). Additionally or alternatively, the UE 115-a may extract the channel power delay profile (PDP) of the other TRP 205 based on a difference of the CIR extracted from both of the reference signals 210.

In some examples, the UE may determine a Doppler shift and a Doppler spread. As an illustrative example, the UE 115-a may determine that the transmission scheme implements Doppler Shift pre-compensation. In some cases, the UE 115-a may determine that the reference signal configuration is a distributed mode. In such examples, the UE 115-a may extract the Doppler shift and Doppler spread from a reference signal 210 from an anchor TRP 205 associated with a TCI state having a QCL type A with QCL parameters Doppler shift and Doppler spread. In some other cases, the UE 115-a may determine that the reference signal configuration is a partial distributed mode. In such examples, the UE 115-a may extract a Doppler shift and a Doppler spread from the reference signal 210 from an anchor TRP 205 associated with a TCI state having a QCL type B with QCL parameters Doppler shift and Doppler spread.

As another illustrative example, the UE 115-a may determine that the transmission scheme is an example of an enhanced SFN scheme without Doppler-shift pre-compensation. In some cases, the UE 115-a may determine that the reference signal configuration is a distributed mode. In such examples, the UE 115-a may extract (e.g., estimate) the Doppler shift and Doppler spread from each TRP 205 based on a respective TRS (e.g., the UE 115-a may determine the parameters from the reference signal 210-a for the TRP 205-a in addition to the reference signal 210-b for the TRP 205-b). In some other cases, the UE 115-a may determine that the reference signal configuration is an SFN configuration (e.g., partial distributed mode). In such examples, the UE 115-a may obtain a first CIR by subtracting a CIR of a first reference signal 210-a and a CIR of a second reference signal 210-b. The UE 115-a may extract the Doppler shift and Doppler spread from the first CIR and use such parameters for a DMRS CE to obtain a time domain auto-correlation for receiving one or more downlink transmissions 230 and/or transmitting one or more uplink transmissions.

Such techniques may thus allow for enhanced reliability in decoding communications from the TRPs 205 through the devices of the wireless communications system more accurately compensating for frequency offsets between communications associated with the multiple TRPs 205.

FIGS. 3A and 3B illustrate examples of wireless communications systems 300 and 301 that support QCL variants for SFN deployments in accordance with aspects of the present disclosure. In some examples, the wireless communications systems 300 and 301 may implement aspects of wireless communications system 100 or 200. For example, the wireless communications systems 300 and 301 may include examples of TRPs 305 and UEs 115, which may be examples of the corresponding devices as described herein. Generally, the wireless communications system 300 may illustrate an example of a first reference signal configuration or scheme (e.g., a distributed mode) and the wireless communications system 301 may illustrate an example of a second reference signal configuration or scheme (e.g., a partially distributed mode).

The wireless communications system 300 may include a UE 115-b in communication with multiple TRPs 305 (e.g., TRP 305-a and TRP 305-b). The wireless communications system 300 may support a partially distributed reference signal configuration (i.e., a backwards compatible configuration). For example, the UE 115-b may receive a higher layer parameter indicating a partially distributed mode (e.g., a “SFN TRS mode” set to partially distributed) as described herein with reference to FIG. 2. In such examples, the TRP 305-a may transmit a TRS 310-a and the TRP 305-b may transmit the TRS 310-a to the UE 115-b in an SFN manner (e.g., the reference signals may use the same configured frequency and time resources). Additionally or alternatively, the TRP 305-a may transmit a second TRS 310-b to the UE 115-b. In some examples, the TRP 305-a and the TRP 305-b may transmit a PDSCH 315 and a DMRS 320 in an SFN manner. Although shown with two TRPs 305, it is to be understood that any quantity of TRPs 305 may be used.

The wireless communications system 301 may include a UE 115-c in communication with multiple TRPs 305 (e.g., TRP 305-c and TRP 305-d). The wireless communications system 301 may support a distributed reference signal configuration. For example, the UE 115-c may receive a higher layer parameter indicating a distributed mode (e.g., a “SFN_TRS_mode” set to distributed) as described herein with reference to FIG. 2. In such examples, the TRP 305-c may transmit a TRS 310-a and the TRP 305-b may transmit a second TRS 310-b to the UE 115-b (e.g., the TRSs 310 may be different and transmitted in a manner different than an SFN manner). In some examples, the TRP 305-a and the TRP 305-b may transmit a PDSCH 315 and a DMRS 320 in an SFN manner. Although shown with two TRPs 305, it is to be understood that any quantity of TRPs 305 may be used.

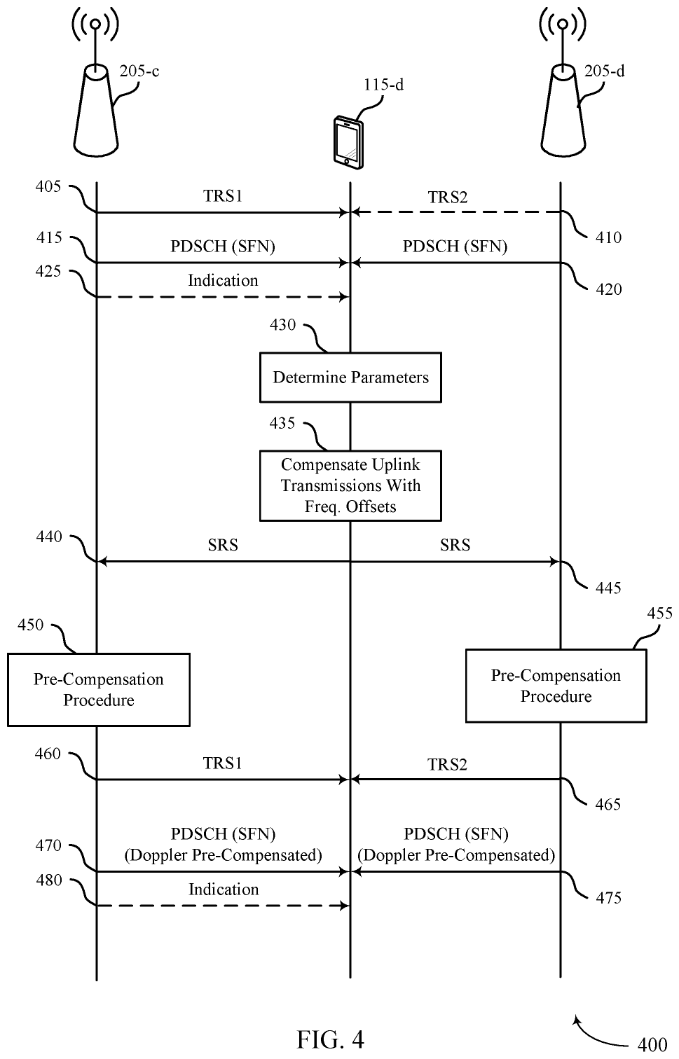

FIG. 4 illustrates an example of a process flow 400 that supports QCL variants for SFN deployments in accordance with aspects of the present disclosure. In some examples, the process flow 400 may implement aspects of wireless communications system 100, 200, 300, or 301. The process flow may include a UE 115-d, a first TRP 205-c, and a second TRP 205-d, which may each be examples of UEs and TRPs as described with reference to FIGS. 1-3. Generally, the process flow 400 may illustrate an example of a pre-compensation scheme for a first reference signal configuration (e.g., a per-TRP reference signal configuration such as a distributed mode).

In the following description of the process flow 400, the communications between the TRPs 205 and the UE 115-d may be transmitted in a different order than the example order shown, or the operations performed by the TRPs 205 and the UE 115-d may be performed in different orders or at different times. Some operations may also be omitted from the process flow 400, and other operations may be added to the process flow 400.

At 405, the TRP 205-c may transmit a first reference signal (e.g., a first TRS) to the UE 115-d. At 410, the TRP 205-d may optionally transmit a second reference signal (e.g., a second TRS2) to the UE 115-d. In some examples, the reference signals may be configured and transmitted in accordance with a distributed mode as described herein with reference to FIGS. 1 and 2.

At 415, the TRP 205-c may transmit a PDSCH message to the UE 115-d. At 420, the TRP 205-d may transmit the PDSCH message to the UE 115-d in an SFN manner with the PDSCH message at 415. For example, the PDSCH message may include the same message transmitted via the same resources from the two or more TRPs 205. In some examples, at 425 the TRP 205-c may send an indication to the UE 115-d that the transmitted PDSCH message is not pre-compensated (e.g., Doppler shift pre-compensated).

At 430, the UE 115-d may determine one or more parameters (e.g., Doppler parameters, QCL parameters, etc.) as described herein. At 435, the UE 115-d may compensate one or more uplink transmissions with frequency offsets. For example, the UE 115-d may adjust the frequency for the transmission of multiple SRSs sent to the TRPs 205 at 440 and 445 using the determined one or more parameters.

At 450, the TRP 205-c may perform a pre-compensation procedure and at 455 the TRP 205-d may perform a pre-compensation procedure. For example, the TRPs 205 may perform Doppler pre-compensation procedures as part of a transmission scheme as described herein with reference to FIG. 2. At 460 and 465, the TRP 205-c may transmit the first TRS and the TRP 205-d may transmit the second TRS to the UE 115-d. At 470, the TRP 205-c may transmit a PDSCH message in an SFN manner in accordance with the pre-compensation scheme. For example, one or both of the TRPs 205-c and 205-d may adjust a frequency or other parameters of the PDSCH messages to pre-compensate the messages and improve reception at the UE 115-d. In some examples, at 480 the TRP 205-c may send an indication that the PDSCH message is pre-compensated.

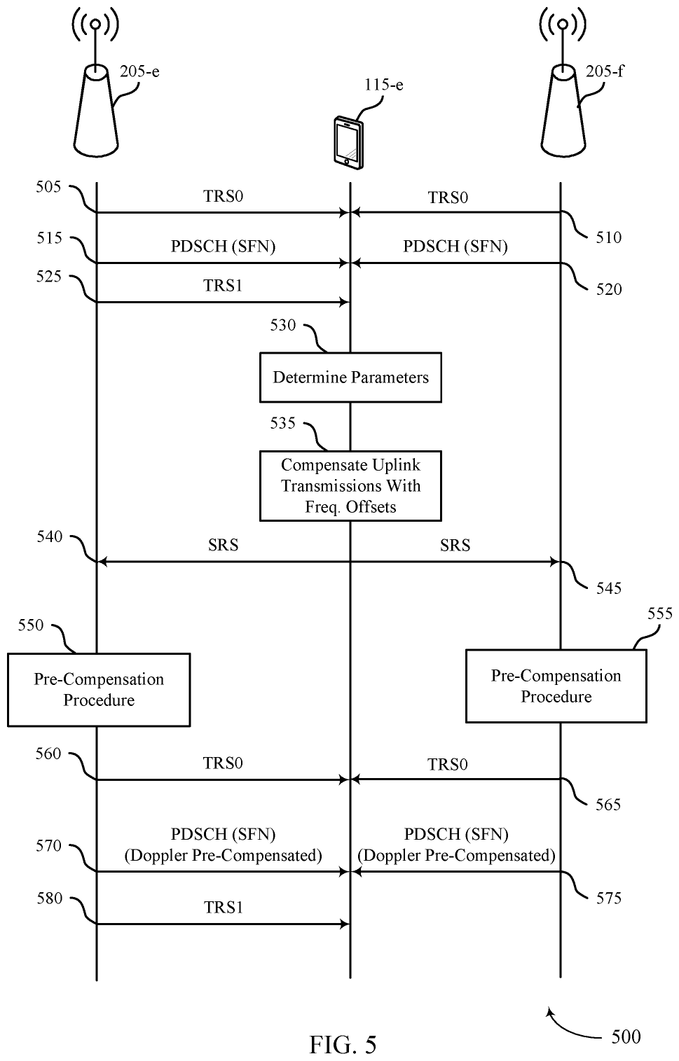

FIG. 5 illustrates an example of a process flow 500 that supports QCL variants for SFN deployments in accordance with aspects of the present disclosure. In some examples, the process flow 500 may implement aspects of wireless communications system 100, 200, 300, or 301. The process flow may include a UE 115-e, a first TRP 205-e, and a second TRP 205-f, which may each be examples of UEs and TRPs as described with reference to FIGS. 1-4. Generally, the process flow 500 may illustrate an example of a pre-compensation scheme for a second reference signal configuration (e.g., an SFN reference signal configuration such as a partially distributed mode).

In the following description of the process flow 500, the communications between the TRPs 205 and the UE 115-e may be transmitted in a different order than the example order shown, or the operations performed by the TRPs 205 and the UE 115-e may be performed in different orders or at different times. Some operations may also be omitted from the process flow 500, and other operations may be added to the process flow 500.

At 505, the TRP 205-e may transmit a first reference signal (e.g., a first TRS) to the UE 115-e. At 510, the TRP 205-f may transmit the first reference signal (e.g., the first TRS) to the UE 115-e. In some examples, the reference signals may be configured and transmitted in accordance with a partially distributed mode as described herein with reference to FIGS. 1 and 2.

At 515, the TRP 205-e may transmit a PDSCH message to the UE 115-e. At 520, the TRP 205-f may transmit the PDSCH message to the UE 115-e in an SFN manner with the PDSCH message at 515. For example, the PDSCH message may include the same message transmitted via the same resources from the two or more TRPs 205. At 525, the TRP 205-e may send a second reference signal (e.g., a second TRS different than the SFN first TRSs sent at 505 and 510).

At 530, the UE 115-e may determine one or more parameters (e.g., Doppler parameters, QCL parameters, etc.) as described herein. At 535, the UE 115-e may compensate one or more uplink transmissions with frequency offsets. For example, the UE 115-e may adjust the frequency for the transmission of multiple SRSs sent to the TRPs 205 at 540 and 545 using the determined one or more parameters.

At 550, the TRP 205-e may perform a pre-compensation procedure and at 555 the TRP 205-f may perform a pre-compensation procedure. For example, the TRPs 205 may perform Doppler pre-compensation procedures as part of a transmission scheme as described herein with reference to FIGS. 2. At 560 and 565, the TRP 205-e and the TRP 205-f may transmit the first TRS to the UE 115-e. At 570, the TRP 205-e may transmit a PDSCH message in an SFN manner in accordance with the pre-compensation scheme. For example, one or both of the TRPs 205-e and 205-f may adjust a frequency or other parameters of the PDSCH messages to pre-compensate the messages and improve reception at the UE 115-e. In some examples, at 580 the TRP 205-e may send the second reference signal to the UE 115-e.

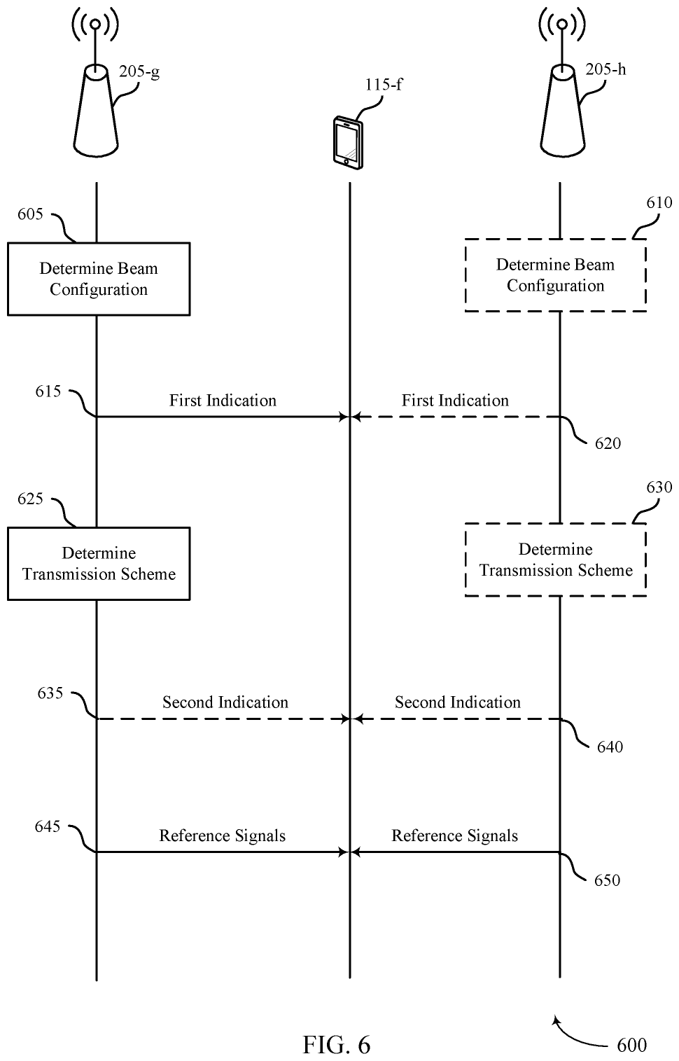

FIG. 6 illustrates an example of a process flow 600 that supports QCL variants for SFN deployments in accordance with aspects of the present disclosure. In some examples, the process flow 600 may implement aspects of wireless communications system 100, 200, 300, or 301, aspects of the process flows 400 or 500, or any combination thereof. The process flow 600 may include a UE 115-f, a first TRP 205-g, and a second TRP 205-h, which may each be examples of UEs and TRPs as described with reference to FIGS. 1-5. In the following description of the process flow 600, the communications between the TRPs 205 and the UE 115-f may be transmitted in a different order than the example order shown, or the operations performed by the TRPs 205 and the UE 115-f may be performed in different orders or at different times. Some operations may also be omitted from the process flow 600, and other operations may be added to the process flow 600.

At 605, the TRP 205-g may determine a beam configuration. For example, the TRP 205-g may determine a TCI state for communications with the UE 115-f, a QCL type, a transmission scheme, a reference signal configuration, or any combination thereof. Additionally or alternatively, at 610 the TRP 205-h may determine a beam configuration for communications with the UE 115-f.

At 615, the TRP 205-g may transmit a first indication to the UE 115-f as described herein with reference to FIG. 2. For example, the first indication may be control signaling indicating a parameter (e.g., a higher layer parameter indicating a reference signal configuration, such as a distributed mode or a partially distributed mode for receiving TRSs). In some examples, at 620 the TRP 205-h may additionally or alternatively transmit the first indication to the UE 115-f.

At 625, the TRP 205-g may determine a transmission scheme. For example, the TRP 205-g may determine whether to implement pre-compensation for communications with the UE 115-f as described herein. In some examples, at 630 the TRP 205-h may additionally or alternatively determine the transmission scheme.

In some examples, at 635 the TRP 205-g may transmit a second indication to the UE 115-f For example, the TRP 205-g may transmit an indication of a TCI state, a QCL type, or both for communications between the UE 115-g and the TRP 205-g. Additionally or alternatively, at 640 the TRP 205-h may transmit a second indication. For example, the TRP 205-h may transmit an indication of a TCI state, a QCL type, or both for communications between the UE 115-g and the TRP 205-h. In some examples, a single TRP 205 may transmit the second indication including the QCL types for each of the multiple TRPs 205. In some examples, the UE may determine a transmission scheme and/or a reference signal configuration based on the first indication and the second indication.

At 645, the TRP 205-g may transmit one or more reference signals in accordance with the determined transmission scheme, reference signal configuration, beam configuration, or any combination thereof. At 650, the TRP 205-h may transmit one or more reference signals in accordance with the determined transmission scheme, reference signal configuration, beam configuration, or any combination thereof.

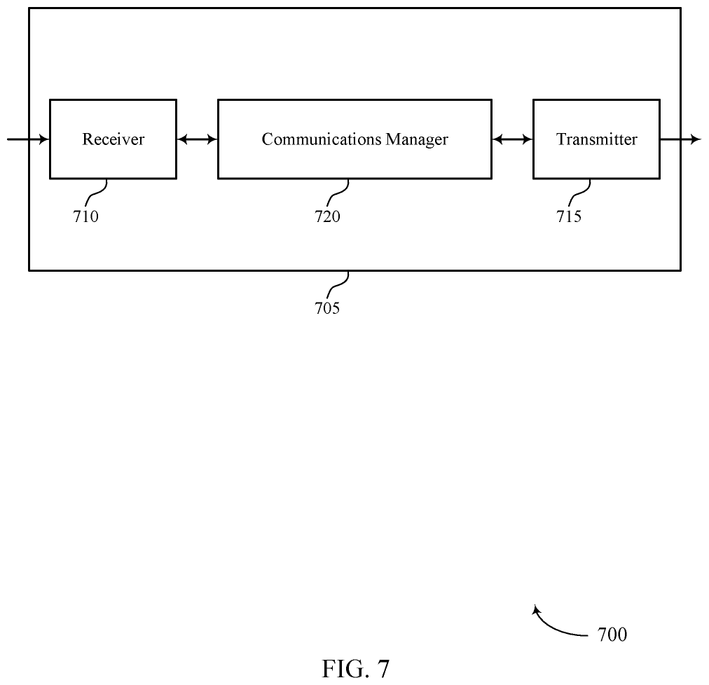

FIG. 7 shows a block diagram 700 of a device 705 that supports QCL variants for SFN deployments in accordance with aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the reference signal features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to QCL variants for SFN deployments). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to QCL variants for SFN deployments). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of QCL variants for SFN deployments as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 720 may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. For example, the communications manager 720 may be configured as or otherwise support a means for receiving a first indication that one or more reference signals correspond to a set of multiple beam configurations, the UE configured to communicate with a set of multiple transmission reception points. The communications manager 720 may be configured as or otherwise support a means for receiving a second indication of a first QCL type and a second QCL type based on receiving the first indication, the first QCL type associated with a first beam configuration corresponding to a first transmission reception point of the set of multiple transmission reception points, and the second QCL type associated with a second beam configuration corresponding to a second transmission reception point of the set of multiple transmission reception points. The communications manager 720 may be configured as or otherwise support a means for determining whether the set of multiple transmission reception points are using a pre-compensation scheme based on the first QCL type and the second QCL type. The communications manager 720 may be configured as or otherwise support a means for receiving the one or more reference signals from the set of multiple transmission reception points based on the determining.

By including or configuring the communications manager 720 in accordance with examples as described herein, the device 705 (e.g., a processor controlling or otherwise coupled to the receiver 710, the transmitter 715, the communications manager 720, or a combination thereof) may support techniques for QCL variants in SFN deployments. For example, the device 705 may support transmission schemes and reference signal configurations corresponding to QCL variants as described herein, which may improve communications efficiency and reliability at the device 705, among other advantages.

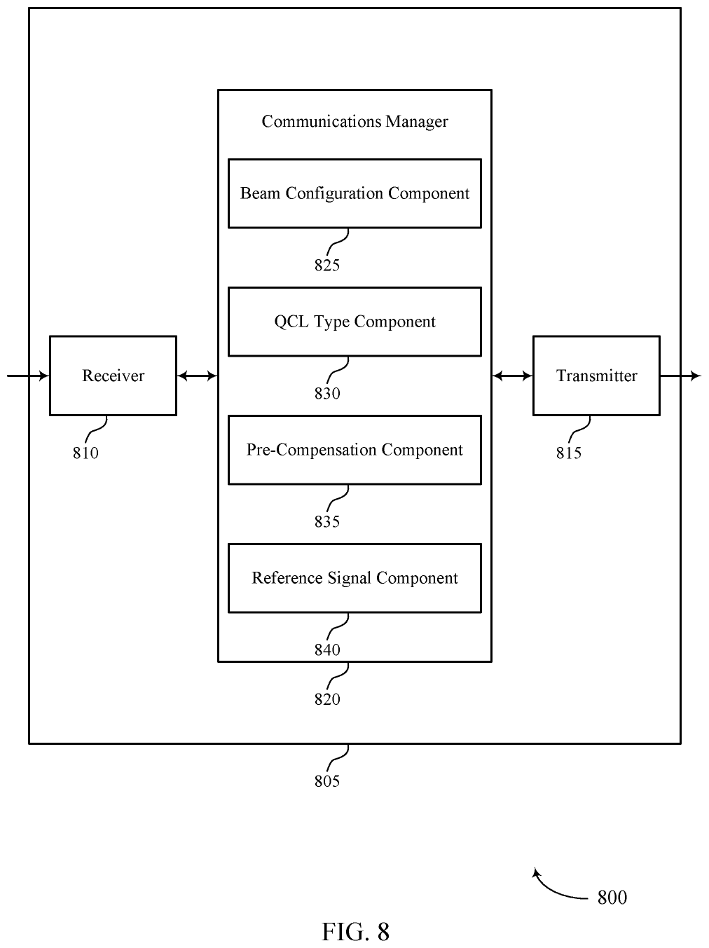

FIG. 8 shows a block diagram 800 of a device 805 that supports QCL variants for SFN deployments in accordance with aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to QCL variants for SFN deployments). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to QCL variants for SFN deployments). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of QCL variants for SFN deployments as described herein. For example, the communications manager 820 may include a beam configuration component 825, a QCL type component 830, a pre-compensation component 835, a reference signal component 840, or any combination thereof. The communications manager 820 may be an example of aspects of a communications manager 720 as described herein. In some examples, the communications manager 820, or various components thereof, may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a UE in accordance with examples as disclosed herein. The beam configuration component 825 may be configured as or otherwise support a means for receiving a first indication that one or more reference signals correspond to a set of multiple beam configurations, the UE configured to communicate with a set of multiple transmission reception points. The QCL type component 830 may be configured as or otherwise support a means for receiving a second indication of a first QCL type and a second QCL type based on receiving the first indication, the first QCL type associated with a first beam configuration corresponding to a first transmission reception point of the set of multiple transmission reception points, and the second QCL type associated with a second beam configuration corresponding to a second transmission reception point of the set of multiple transmission reception points. The pre-compensation component 835 may be configured as or otherwise support a means for determining whether the set of multiple transmission reception points are using a pre-compensation scheme based on the first QCL type and the second QCL type. The reference signal component 840 may be configured as or otherwise support a means for receiving the one or more reference signals from the set of multiple transmission reception points based on the determining.

In some cases, the beam configuration component 825, the QCL type component 830, the pre-compensation component 835, and the reference signal component 840 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the beam configuration component 825, the QCL type component 830, the pre-compensation component 835, and the reference signal component 840 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

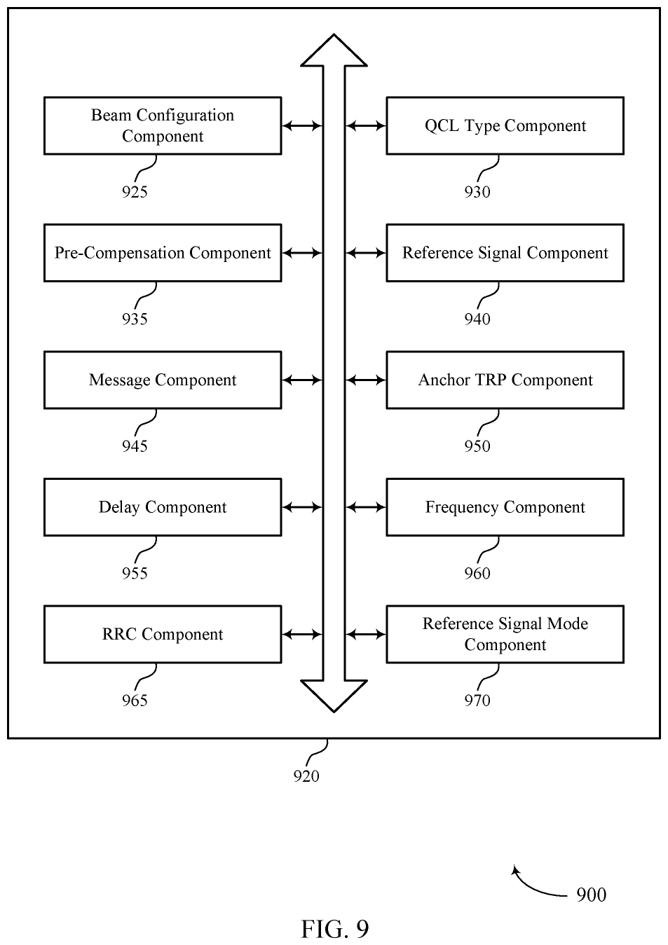

FIG. 9 shows a block diagram 900 of a communications manager 920 that supports QCL variants for SFN deployments in accordance with aspects of the present disclosure. The communications manager 920 may be an example of aspects of a communications manager 720, a communications manager 820, or both, as described herein. The communications manager 920, or various components thereof, may be an example of means for performing various aspects of QCL variants for SFN deployments as described herein. For example, the communications manager 920 may include a beam configuration component 925, a QCL type component 930, a pre-compensation component 935, a reference signal component 940, a message component 945, an anchor TRP component 950, a delay component 955, a frequency component 960, an RRC component 965, a reference signal mode component 970, or any combination thereof. Each of these components may communicate, directly or indirectly, with one another (e.g., via one or more buses).

The communications manager 920 may support wireless communications at a UE in accordance with examples as disclosed herein. The beam configuration component 925 may be configured as or otherwise support a means for receiving a first indication that one or more reference signals correspond to a set of multiple beam configurations, the UE configured to communicate with a set of multiple transmission reception points. The QCL type component 930 may be configured as or otherwise support a means for receiving a second indication of a first QCL type and a second QCL type based on receiving the first indication, the first QCL type associated with a first beam configuration corresponding to a first transmission reception point of the set of multiple transmission reception points, and the second QCL type associated with a second beam configuration corresponding to a second transmission reception point of the set of multiple transmission reception points. The pre-compensation component 935 may be configured as or otherwise support a means for determining whether the set of multiple transmission reception points are using a pre-compensation scheme based on the first QCL type and the second QCL type. The reference signal component 940 may be configured as or otherwise support a means for receiving the one or more reference signals from the set of multiple transmission reception points based on the determining.

In some examples, the pre-compensation component 935 may be configured as or otherwise support a means for determining that the one or more transmission reception points of the set of multiple transmission reception points are implementing the pre-compensation scheme based on the first QCL type being different from the second QCL type.

In some examples, the reference signal component 940 may be configured as or otherwise support a means for receiving a first reference signal from a first transmission reception point and a second reference signal from a second transmission reception point. In some examples, the message component 945 may be configured as or otherwise support a means for receiving a downlink message from the first transmission reception point and the second transmission reception point in accordance with the pre-compensation scheme based on receiving the first reference signal and the second reference signal.

In some examples, the reference signal component 940 may be configured as or otherwise support a means for receiving a first reference signal from a first transmission reception point and the first reference signal from a second transmission reception point. In some examples, the reference signal component 940 may be configured as or otherwise support a means for receiving a second reference signal from the first transmission reception point or the second transmission reception point. In some examples, the message component 945 may be configured as or otherwise support a means for receiving a downlink message from the first transmission reception point and the second transmission reception point in accordance with the pre-compensation scheme based on receiving the first reference signal, the second reference signal, or both.

In some examples, the reference signal component 940 may be configured as or otherwise support a means for receiving a first reference signal from a first transmission reception point and a second reference signal from a second transmission reception point. In some examples, the message component 945 may be configured as or otherwise support a means for receiving a downlink message from the first transmission reception point and the second transmission reception point in accordance with the pre-compensation scheme based on receiving the first reference signal and the second reference signal.

In some examples, the reference signal component 940 may be configured as or otherwise support a means for receiving a first reference signal from a first transmission reception point and a second reference signal from a second transmission reception point. In some examples, the message component 945 may be configured as or otherwise support a means for receiving, via a set of resources, a downlink message from the first transmission reception point based on the first reference signal. In some examples, the message component 945 may be configured as or otherwise support a means for receiving, via the set of resources, the downlink message from the second transmission reception point based on the second reference signal.

In some examples, the reference signal component 940 may be configured as or otherwise support a means for receiving a third reference signal from the first transmission reception point and the second transmission reception point, the downlink message received further based on the third reference signal.

In some examples, the anchor TRP component 950 may be configured as or otherwise support a means for identifying an anchor transmission reception point from the set of multiple transmission reception points based on a first beam configuration of the set of multiple beam configurations, a beam configuration with a lowest index, a third indication of the anchor transmission reception point included in a configuration of the plurality beam configurations, a fourth indication in a medium access control (MAC) control element, a fifth indication to refrain from using a parameter of a beam configuration, or any combination thereof.

In some examples, the delay component 955 may be configured as or otherwise support a means for determining an average delay and a delay spread based on determining whether one or more transmission reception points of the set of multiple transmission reception points are implementing a pre-compensation scheme and the one or more reference signals.

In some examples, the frequency component 960 may be configured as or otherwise support a means for determining a Doppler shift and a Doppler spread from a reference signal of an anchor transmission reception point based on determining whether one or more transmission reception points of the set of multiple transmission reception points are implementing a pre-compensation scheme and the one or more reference signals.

In some examples, to support receiving the first indication, the RRC component 965 may be configured as or otherwise support a means for receiving a radio resource control message including the first indication, the first indication including a higher layer parameter. In some examples, the higher layer parameter indicates an SFN downlink transmission from the set of transmission reception points associated with the set of beam configurations. In some examples, the higher layer parameter is configured as part of a PDSCH higher layer configuration, a PDCCH control resource set configuration, or a combination thereof. In some examples, the higher layer parameter indicates a transmission scheme associated with the reference signal configuration.

In some examples, the reference signal mode component 970 may be configured as or otherwise support a means for determining a reference signal mode based on receiving the first indication, where the reference signal mode includes a distributed tracking reference signal mode or a partially distributed tracking reference signal mode.

In some examples, the set of multiple beam configurations include a set of multiple transmission configuration indicator states.

In some examples, the reference signal component 940 may be configured as or otherwise support a means for determining one or more QCL parameters based on receiving the one or more reference signals. In some examples, the message component 945 may be configured as or otherwise support a means for receiving a downlink message from the first transmission reception point and the second transmission reception point using the determined one or more QCL parameters.

In some cases, the beam configuration component 925, the QCL type component 930, the pre-compensation component 935, the reference signal component 940, the message component 945, the anchor TRP component 950, the delay component 955, the frequency component 960, the RRC component 965, and the reference signal mode component 970 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the beam configuration component 925, the QCL type component 930, the pre-compensation component 935, the reference signal component 940, the message component 945, the anchor TRP component 950, the delay component 955, the frequency component 960, the RRC component 965, and the reference signal mode component 970 discussed herein.

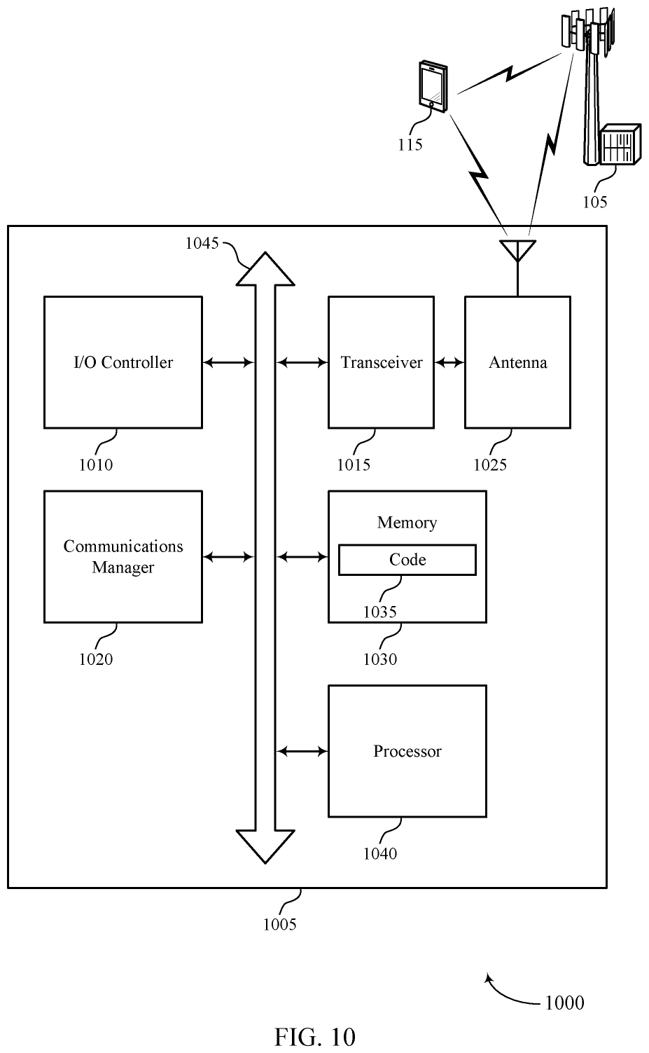

FIG. 10 shows a diagram of a system 1000 including a device 1005 that supports QCL variants for SFN deployments in accordance with aspects of the present disclosure. The device 1005 may be an example of or include the components of a device 705, a device 805, or a UE 115 as described herein. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting QCL variants for SFN deployments). For example, the device 1005 or a component of the device 1005 may include a processor 1040 and memory 1030 coupled to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving a first indication that one or more reference signals correspond to a set of multiple beam configurations, the UE configured to communicate with a set of multiple transmission reception points. The communications manager 1020 may be configured as or otherwise support a means for receiving a second indication of a first QCL type and a second QCL type based on receiving the first indication, the first QCL type associated with a first beam configuration corresponding to a first transmission reception point of the set of multiple transmission reception points, and the second QCL type associated with a second beam configuration corresponding to a second transmission reception point of the set of multiple transmission reception points. The communications manager 1020 may be configured as or otherwise support a means for determining whether the set of multiple transmission reception points are using a pre-compensation scheme based on the first QCL type and the second QCL type. The communications manager 1020 may be configured as or otherwise support a means for receiving the one or more reference signals from the set of multiple transmission reception points based on the determining.

By including or configuring the communications manager 1020 in accordance with examples as described herein, the device 1005 may support techniques for transmission schemes and reference signal configurations corresponding to QCL variants as described herein, which may improve communications efficiency and reliability at the device 1005, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of QCL variants for SFN deployments as described herein, or the processor 1040 and the memory 1030 may be otherwise configured to perform or support such operations.

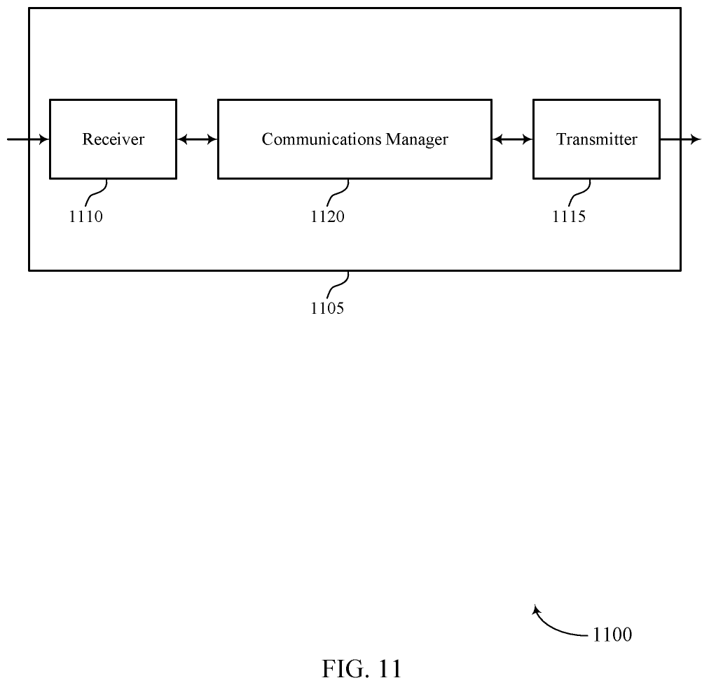

FIG. 11 shows a block diagram 1100 of a device 1105 that supports QCL variants for SFN deployments in accordance with aspects of the present disclosure. The device 1105 may be an example of aspects of a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to QCL variants for SFN deployments). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to QCL variants for SFN deployments). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of QCL variants for SFN deployments as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1120 may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a transmission reception point in accordance with examples as disclosed herein. For example, the communications manager 1120 may be configured as or otherwise support a means for transmitting, to a UE, a first indication that one or more reference signals correspond to a set of multiple beam configurations, the UE configured to communicate with a set of multiple transmission reception points. The communications manager 1120 may be configured as or otherwise support a means for determining whether to use a pre-compensation scheme to communicate with the UE using the set of multiple transmission reception points. The communications manager 1120 may be configured as or otherwise support a means for transmitting a second indication of a first QCL type and a second QCL type based on determining whether the pre-compensation scheme is to be used, the first QCL type associated with a first beam configuration corresponding to a first transmission reception point of the set of multiple transmission reception points, and the second QCL type associated with a second beam configuration corresponding to a second transmission reception point of the set of multiple transmission reception points. The communications manager 1120 may be configured as or otherwise support a means for transmitting the one or more reference signals according to the first QCL type and a second QCL type.

By including or configuring the communications manager 1120 in accordance with examples as described herein, the device 1105 (e.g., a processor controlling or otherwise coupled to the receiver 1110, the transmitter 1115, the communications manager 1120, or a combination thereof) may support techniques for transmission schemes and reference signal configurations corresponding to QCL variants as described herein, which may improve communications efficiency and reliability, among other advantages.

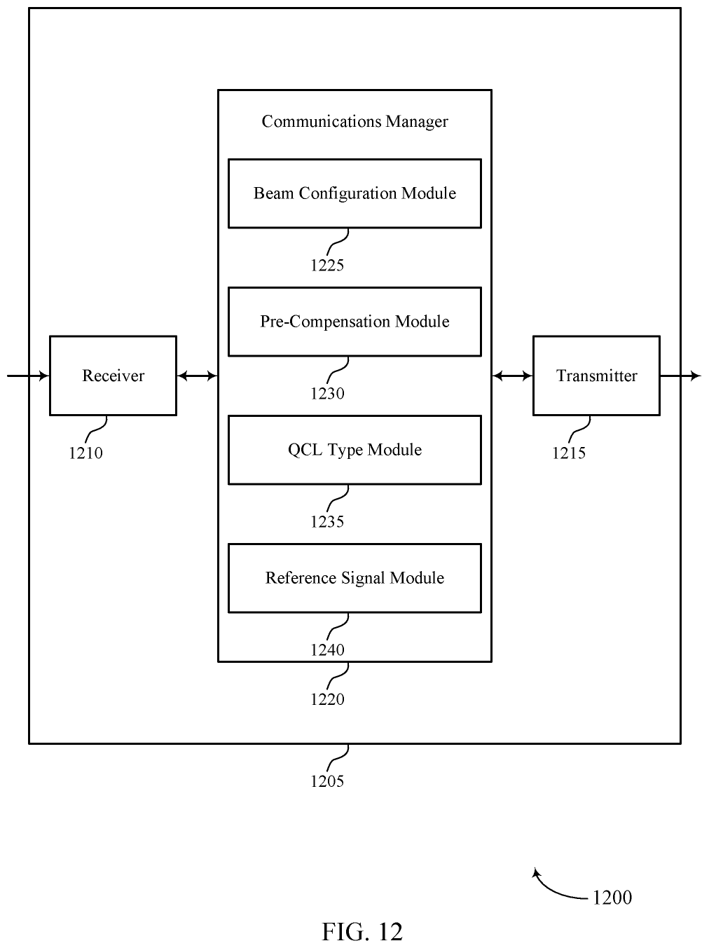

FIG. 12 shows a block diagram 1200 of a device 1205 that supports QCL variants for SFN deployments in accordance with aspects of the present disclosure. The device 1205 may be an example of aspects of a device 1105 or a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to QCL variants for SFN deployments). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to QCL variants for SFN deployments). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of QCL variants for SFN deployments as described herein. For example, the communications manager 1220 may include a beam configuration module 1225, a pre-compensation module 1230, a QCL type module 1235, a reference signal module 1240, or any combination thereof. The communications manager 1220 may be an example of aspects of a communications manager 1120 as described herein. In some examples, the communications manager 1220, or various components thereof, may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a transmission reception point in accordance with examples as disclosed herein. The beam configuration module 1225 may be configured as or otherwise support a means for transmitting, to a UE, a first indication that one or more reference signals correspond to a set of multiple beam configurations, the UE configured to communicate with a set of multiple transmission reception points. The pre-compensation module 1230 may be configured as or otherwise support a means for determining whether to use a pre-compensation scheme to communicate with the UE using the set of multiple transmission reception points. The QCL type module 1235 may be configured as or otherwise support a means for transmitting a second indication of a first QCL type and a second QCL type based on determining whether the pre-compensation scheme is to be used, the first QCL type associated with a first beam configuration corresponding to a first transmission reception point of the set of multiple transmission reception points, and the second QCL type associated with a second beam configuration corresponding to a second transmission reception point of the set of multiple transmission reception points. The reference signal module 1240 may be configured as or otherwise support a means for transmitting the one or more reference signals according to the first QCL type and a second QCL type.

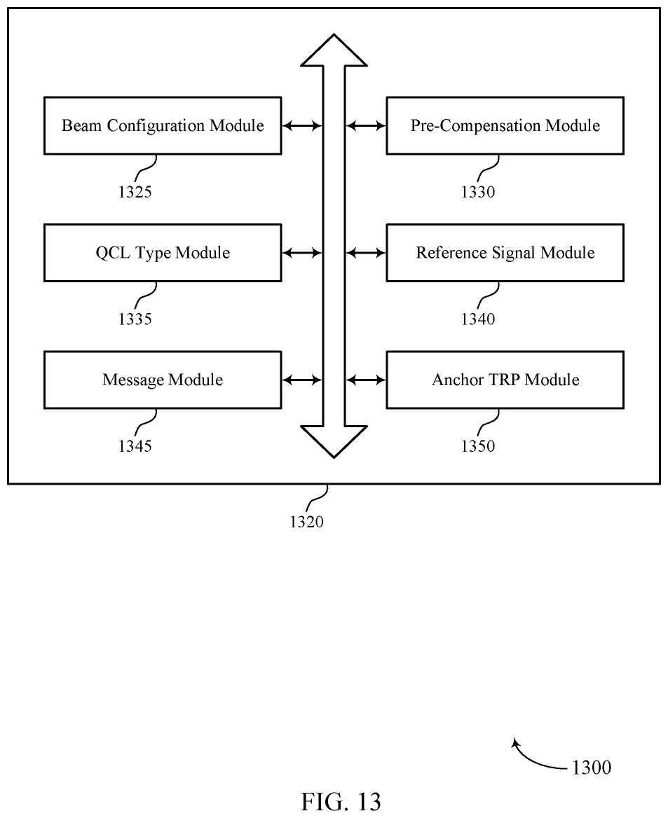

FIG. 13 shows a block diagram 1300 of a communications manager 1320 that supports QCL variants for SFN deployments in accordance with aspects of the present disclosure. The communications manager 1320 may be an example of aspects of a communications manager 1120, a communications manager 1220, or both, as described herein. The communications manager 1320, or various components thereof, may be an example of means for performing various aspects of QCL variants for SFN deployments as described herein. For example, the communications manager 1320 may include a beam configuration module 1325, a pre-compensation module 1330, a QCL type module 1335, a reference signal module 1340, a message module 1345, an anchor TRP module 1350, or any combination thereof. Each of these components may communicate, directly or indirectly, with one another (e.g., via one or more buses).

The communications manager 1320 may support wireless communications at a transmission reception point in accordance with examples as disclosed herein. The beam configuration module 1325 may be configured as or otherwise support a means for transmitting, to a UE, a first indication that one or more reference signals correspond to a set of multiple beam configurations, the UE configured to communicate with a set of multiple transmission reception points. The pre-compensation module 1330 may be configured as or otherwise support a means for determining whether to use a pre-compensation scheme to communicate with the UE using the set of multiple transmission reception points. The QCL type module 1335 may be configured as or otherwise support a means for transmitting a second indication of a first QCL type and a second QCL type based on determining whether the pre-compensation scheme is to be used, the first QCL type associated with a first beam configuration corresponding to a first transmission reception point of the set of multiple transmission reception points, and the second QCL type associated with a second beam configuration corresponding to a second transmission reception point of the set of multiple transmission reception points. The reference signal module 1340 may be configured as or otherwise support a means for transmitting the one or more reference signals according to the first QCL type and a second QCL type.

In some examples, the pre-compensation module 1330 may be configured as or otherwise support a means for determining to implement the pre-compensation scheme, where the second indication indicates that the first QCL type being different from the second QCL type based on the pre-compensation scheme being different.

In some examples, the reference signal module 1340 may be configured as or otherwise support a means for transmitting a first reference signal from the first transmission reception point different from a second reference signal from the second transmission reception point. In some examples, the message module 1345 may be configured as or otherwise support a means for transmitting a downlink message in accordance with the pre-compensation scheme based on transmitting the first reference signal.

In some examples, the reference signal module 1340 may be configured as or otherwise support a means for transmitting a first reference signal. In some examples, the message module 1345 may be configured as or otherwise support a means for transmitting a downlink message in accordance with the pre-compensation scheme based on transmitting the first reference signal.

In some examples, the reference signal module 1340 may be configured as or otherwise support a means for transmitting a first reference signal different from a second reference signal from a second transmission reception point. In some examples, the message module 1345 may be configured as or otherwise support a means for transmitting a downlink message in accordance with the pre-compensation scheme based on transmitting the first reference signal and the second reference signal.

In some examples, the reference signal module 1340 may be configured as or otherwise support a means for transmitting a first reference signal from the first transmission reception point different from a second reference signal from the second transmission reception point. In some examples, the message module 1345 may be configured as or otherwise support a means for transmitting, via a set of resources, a downlink message to the UE based on transmitting the first reference signal.

In some examples, the reference signal module 1340 may be configured as or otherwise support a means for transmitting a third reference signal to the UE.

In some examples, to support None, the anchor TRP module 1350 may be configured as or otherwise support a means for transmitting, to the UE, a third indication of the anchor transmission reception point included in a configuration of the plurality beam configurations, a fourth indication in a medium access control (MAC) control element command message, a fifth indication to refrain from using a parameter of a beam configuration, or any combination thereof.

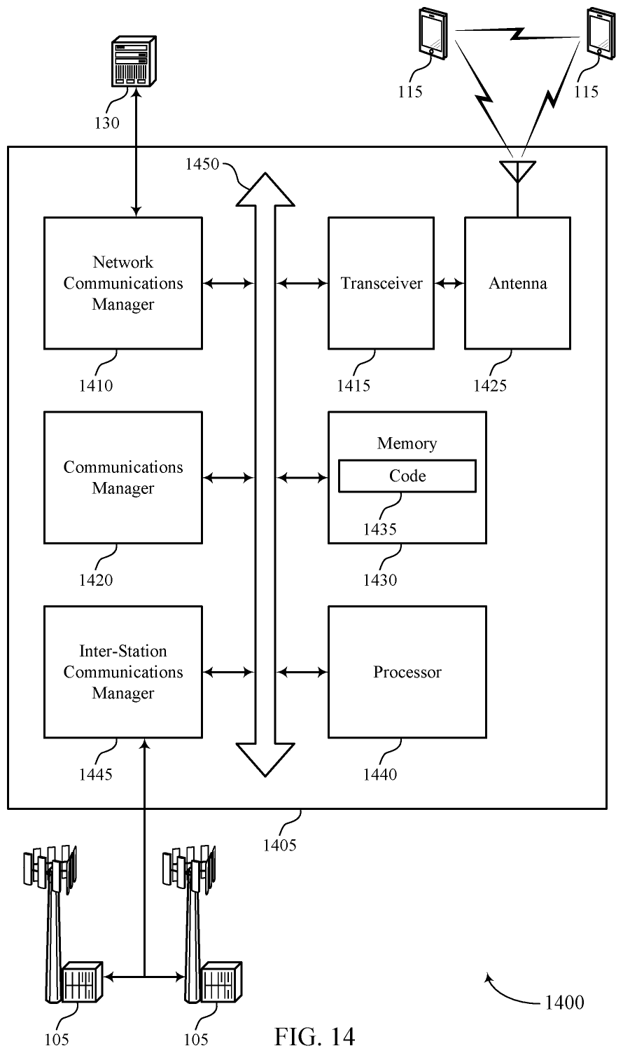

FIG. 14 shows a diagram of a system 1400 including a device 1405 that supports QCL variants for SFN deployments in accordance with aspects of the present disclosure. The device 1405 may be an example of or include the components of a device 1105, a device 1205, or a base station 105 as described herein. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (e.g., operatively, communicatively, functionally, electronically, electrically) via one or more buses (e.g., a bus 1450).

The network communications manager 1410 may manage communications with a core network 130 (e.g., via one or more wired backhaul links). For example, the network communications manager 1410 may manage the transfer of data communications for client devices, such as one or more UEs 115.

In some cases, the device 1405 may include a single antenna 1425. However, in some other cases the device 1405 may have more than one antenna 1425, which may be capable of concurrently transmitting or receiving multiple wireless transmissions. The transceiver 1415 may communicate bi-directionally, via the one or more antennas 1425, wired, or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some cases, the code 1435 may not be directly executable by the processor 1440 but may cause a computer (e.g., when compiled and executed) to perform functions described herein. In some cases, the memory 1430 may contain, among other things, a BIOS which may control basic hardware or software operation such as the interaction with peripheral components or devices.

The processor 1440 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1440 may be configured to operate a memory array using a memory controller. In some other cases, a memory controller may be integrated into the processor 1440. The processor 1440 may be configured to execute computer-readable instructions stored in a memory (e.g., the memory 1430) to cause the device 1405 to perform various functions (e.g., functions or tasks supporting QCL variants for SFN deployments). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communications at a transmission reception point in accordance with examples as disclosed herein. For example, the communications manager 1420 may be configured as or otherwise support a means for transmitting, to a UE, a first indication that one or more reference signals correspond to a set of multiple beam configurations, the UE configured to communicate with a set of multiple transmission reception points. The communications manager 1420 may be configured as or otherwise support a means for determining whether to use a pre-compensation scheme to communicate with the UE using the set of multiple transmission reception points. The communications manager 1420 may be configured as or otherwise support a means for transmitting a second indication of a first QCL type and a second QCL type based on determining whether the pre-compensation scheme is to be used, the first QCL type associated with a first beam configuration corresponding to a first transmission reception point of the set of multiple transmission reception points, and the second QCL type associated with a second beam configuration corresponding to a second transmission reception point of the set of multiple transmission reception points. The communications manager 1420 may be configured as or otherwise support a means for transmitting the one or more reference signals according to the first QCL type and a second QCL type.

By including or configuring the communications manager 1420 in accordance with examples as described herein, the device 1405 may support techniques for transmission schemes and reference signal configurations corresponding to QCL variants as described herein, which may improve communications efficiency and reliability, among other advantages.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of QCL variants for SFN deployments as described herein, or the processor 1440 and the memory 1430 may be otherwise configured to perform or support such operations.

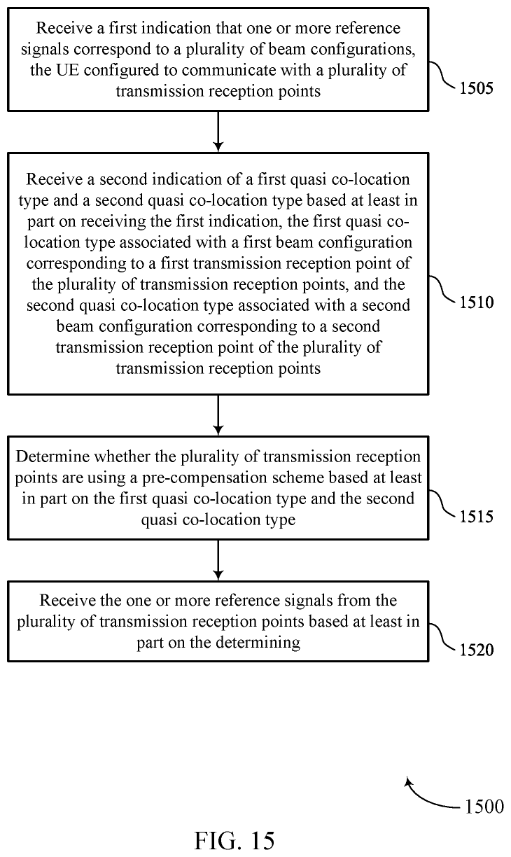

FIG. 15 shows a flowchart illustrating a method 1500 that supports QCL variants for SFN deployments in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1505, the method may include receiving a first indication that one or more reference signals correspond to a set of multiple beam configurations, the UE configured to communicate with a set of multiple transmission reception points. The operations of 1505 may be performed in accordance with examples as disclosed herein. In some examples, aspects of the operations of 1505 may be performed by a beam configuration component 925 as described with reference to FIG. 9.

At 1510, the method may include receiving a second indication of a first quasi co-location type and a second quasi co-location type based on receiving the first indication, the first quasi co-location type associated with a first beam configuration corresponding to a first transmission reception point of the set of multiple transmission reception points, and the second quasi co-location type associated with a second beam configuration corresponding to a second transmission reception point of the set of multiple transmission reception points. The operations of 1510 may be performed in accordance with examples as disclosed herein. In some examples, aspects of the operations of 1510 may be performed by a QCL type component 930 as described with reference to FIG. 9.

At 1515, the method may include determining whether the set of multiple transmission reception points are using a pre-compensation scheme based on the first quasi co-location type and the second quasi co-location type. The operations of 1515 may be performed in accordance with examples as disclosed herein. In some examples, aspects of the operations of 1515 may be performed by a pre-compensation component 935 as described with reference to FIG. 9.

At 1520, the method may include receiving the one or more reference signals from the set of multiple transmission reception points based on the determining. The operations of 1520 may be performed in accordance with examples as disclosed herein. In some examples, aspects of the operations of 1520 may be performed by a reference signal component 940 as described with reference to FIG. 9.

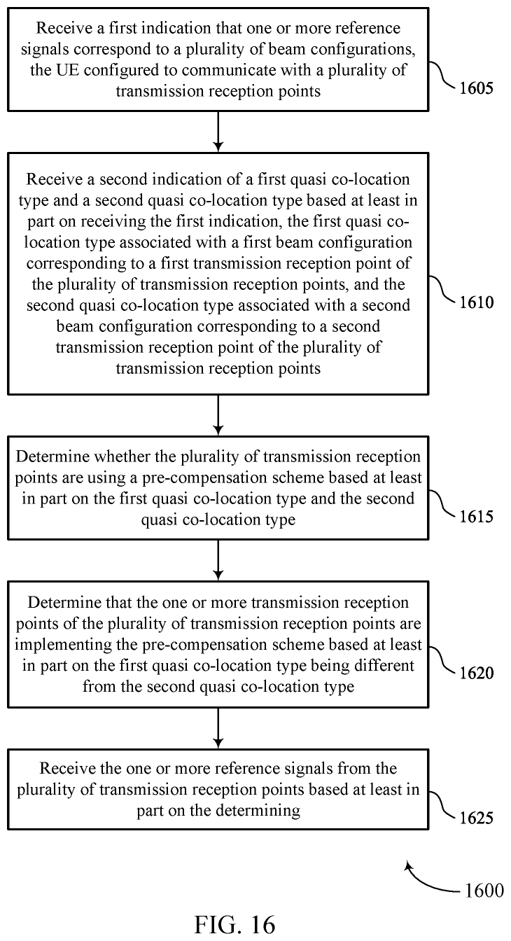

FIG. 16 shows a flowchart illustrating a method 1600 that supports QCL variants for SFN deployments in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally or alternatively, the UE may perform aspects of the described functions using special-purpose hardware.

At 1605, the method may include receiving a first indication that one or more reference signals correspond to a set of multiple beam configurations, the UE configured to communicate with a set of multiple transmission reception points. The operations of 1605 may be performed in accordance with examples as disclosed herein. In some examples, aspects of the operations of 1605 may be performed by a beam configuration component 925 as described with reference to FIG. 9.

At 1610, the method may include receiving a second indication of a first quasi co-location type and a second quasi co-location type based on receiving the first indication, the first quasi co-location type associated with a first beam configuration corresponding to a first transmission reception point of the set of multiple transmission reception points, and the second quasi co-location type associated with a second beam configuration corresponding to a second transmission reception point of the set of multiple transmission reception points. The operations of 1610 may be performed in accordance with examples as disclosed herein. In some examples, aspects of the operations of 1610 may be performed by a QCL type component 930 as described with reference to FIG. 9.

At 1615, the method may include determining whether the set of multiple transmission reception points are using a pre-compensation scheme based on the first quasi co-location type and the second quasi co-location type. The operations of 1615 may be performed in accordance with examples as disclosed herein. In some examples, aspects of the operations of 1615 may be performed by a pre-compensation component 935 as described with reference to FIG. 9.

At 1620, the method may include determining that the one or more transmission reception points of the set of multiple transmission reception points are implementing the pre-compensation scheme based on the first quasi co-location type being different from the second quasi co-location type. The operations of 1620 may be performed in accordance with examples as disclosed herein. In some examples, aspects of the operations of 1620 may be performed by a pre-compensation component 935 as described with reference to FIG. 9.

At 1625, the method may include receiving the one or more reference signals from the set of multiple transmission reception points based on the determining. The operations of 1625 may be performed in accordance with examples as disclosed herein. In some examples, aspects of the operations of 1625 may be performed by a reference signal component 940 as described with reference to FIG. 9.

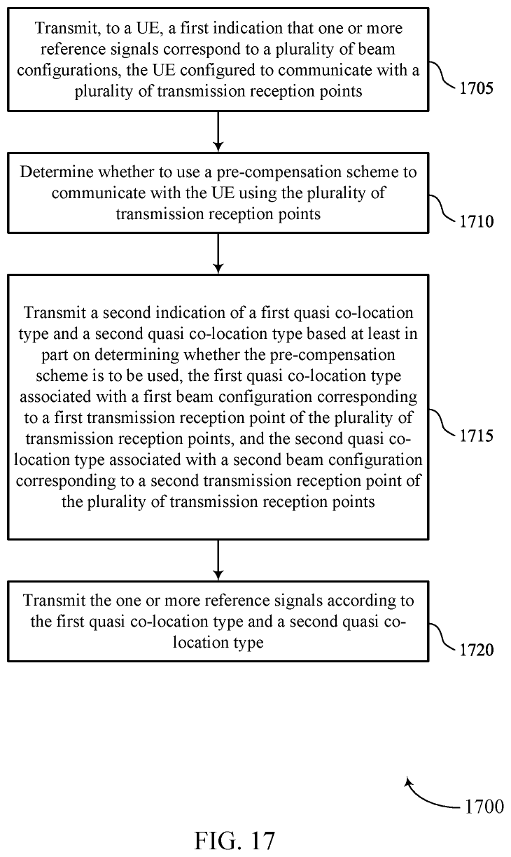

FIG. 17 shows a flowchart illustrating a method 1700 that supports QCL variants for SFN deployments in accordance with aspects of the present disclosure. The operations of the method 1700 may be implemented by a base station or its components as described herein. For example, the operations of the method 1700 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, a first indication that one or more reference signals correspond to a set of multiple beam configurations, the UE configured to communicate with a set of multiple transmission reception points. The operations of 1705 may be performed in accordance with examples as disclosed herein. In some examples, aspects of the operations of 1705 may be performed by a beam configuration module 1325 as described with reference to FIG. 13.

At 1710, the method may include determining whether to use a pre-compensation scheme to communicate with the UE using the set of multiple transmission reception points. The operations of 1710 may be performed in accordance with examples as disclosed herein. In some examples, aspects of the operations of 1710 may be performed by a pre-compensation module 1330 as described with reference to FIG. 13.

At 1715, the method may include transmitting a second indication of a first quasi co-location type and a second quasi co-location type based on determining whether the pre-compensation scheme is to be used, the first quasi co-location type associated with a first beam configuration corresponding to a first transmission reception point of the set of multiple transmission reception points, and the second quasi co-location type associated with a second beam configuration corresponding to a second transmission reception point of the set of multiple transmission reception points. The operations of 1715 may be performed in accordance with examples as disclosed herein. In some examples, aspects of the operations of 1715 may be performed by a QCL type module 1335 as described with reference to FIG. 13.

At 1720, the method may include transmitting the one or more reference signals according to the first quasi co-location type and a second quasi co-location type. The operations of 1720 may be performed in accordance with examples as disclosed herein. In some examples, aspects of the operations of 1720 may be performed by a reference signal module 1340 as described with reference to FIG. 13.

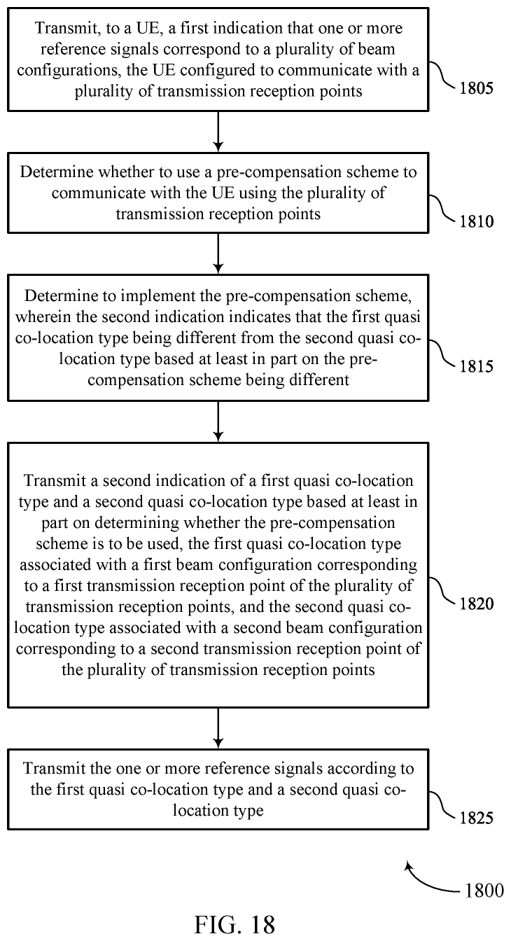

FIG. 18 shows a flowchart illustrating a method 1800 that supports QCL variants for SFN deployments in accordance with aspects of the present disclosure. The operations of the method 1800 may be implemented by a base station or its components as described herein. For example, the operations of the method 1800 may be performed by a base station 105 as described with reference to FIGS. 1 through 6 and 11 through 14. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, a first indication that one or more reference signals correspond to a set of multiple beam configurations, the UE configured to communicate with a set of multiple transmission reception points. The operations of 1805 may be performed in accordance with examples as disclosed herein. In some examples, aspects of the operations of 1805 may be performed by a beam configuration module 1325 as described with reference to FIG. 13.

At 1810, the method may include determining whether to use a pre-compensation scheme to communicate with the UE using the set of multiple transmission reception points. The operations of 1810 may be performed in accordance with examples as disclosed herein. In some examples, aspects of the operations of 1810 may be performed by a pre-compensation module 1330 as described with reference to FIG. 13.

At 1815, the method may include determining to implement the pre-compensation scheme, where the second indication indicates that the first quasi co-location type being different from the second quasi co-location type based on the pre-compensation scheme being different. The operations of 1815 may be performed in accordance with examples as disclosed herein. In some examples, aspects of the operations of 1815 may be performed by a pre-compensation module 1330 as described with reference to FIG. 13.

At 1820, the method may include transmitting a second indication of a first quasi co-location type and a second quasi co-location type based on determining whether the pre-compensation scheme is to be used, the first quasi co-location type associated with a first beam configuration corresponding to a first transmission reception point of the set of multiple transmission reception points, and the second quasi co-location type associated with a second beam configuration corresponding to a second transmission reception point of the set of multiple transmission reception points. The operations of 1820 may be performed in accordance with examples as disclosed herein. In some examples, aspects of the operations of 1820 may be performed by a QCL type module 1335 as described with reference to FIG. 13.

At 1825, the method may include transmitting the one or more reference signals according to the first quasi co-location type and a second quasi co-location type. The operations of 1825 may be performed in accordance with examples as disclosed herein. In some examples, aspects of the operations of 1825 may be performed by a reference signal module 1340 as described with reference to FIG. 13.

The following provides an overview of aspects of the present disclosure:

Aspect 1: A method for wireless communications at a UE, comprising: receiving a first indication that one or more reference signals correspond to a plurality of beam configurations, the UE configured to communicate with a plurality of TRPs; receiving a second indication of a first QCL type and a second QCL type based at least in part on receiving the first indication, the first QCL type associated with a first beam configuration corresponding to a first TRP of the plurality of TRPs, and the second QCL type associated with a second beam configuration corresponding to a second TRP of the plurality of TRPs; and determining whether the plurality of TRPs is using a pre-compensation scheme based at least in part on the first QCL type and the second QCL type; and receiving the one or more reference signals from the plurality of TRPs based at least in part on the determining.

Aspect 2: The method of aspect 1, further comprising: determining that one or more TRPs of the plurality of TRPs are implementing the pre-compensation scheme based at least in part on the first QCL type being different from the second QCL type.

Aspect 3: The method of aspect 2, wherein the first QCL type corresponds to an average delay and a delay spread and the second QCL type corresponds to the average delay, the delay spread, a Doppler shift, and a Doppler spread, further comprising: receiving a first reference signal from the first TRP and a second reference signal from the second TRP; and receiving a downlink message from the first TRP and the second TRP in accordance with the pre-compensation scheme based at least in part on receiving the first reference signal and the second reference signal.

Aspect 4: The method of any of aspects 2 through 3, wherein the first QCL type corresponds to an average delay and a delay spread and the second QCL type corresponds to a Doppler shift and a Doppler spread, further comprising: receiving a first reference signal from the first TRP and the first reference signal from the second TRP; receiving a second reference signal from the first TRP or the second TRP; and receiving a downlink message from the first TRP and the second TRP in accordance with the pre-compensation scheme based at least in part on receiving the first reference signal, the second reference signal, or both.

Aspect 5: The method of any of aspects 2 through 4, wherein the first QCL type corresponds to a delay spread and the second QCL type corresponds to an average delay, the delay spread, a Doppler shift, and a Doppler spread, further comprising: receiving a first reference signal from the first TRP and a second reference signal from the second TRP; and receiving a downlink message from the first TRP and the second TRP in accordance with the pre-compensation scheme based at least in part on receiving the first reference signal and the second reference signal.

Aspect 6: The method of aspect 1, wherein the first QCL type is a same QCL type as the second QCL type, further comprising: receiving a first reference signal from the first TRP and a second reference signal from the second TRP; receiving, via a set of resources, a downlink message from the first TRP based at least in part on the first reference signal; and receiving, via the set of resources, the downlink message from the second TRP based at least in part on the second reference signal.

Aspect 7: The method of aspect 6, further comprising: receiving a third reference signal from the first TRP and the second TRP, the downlink message received further based at least in part on the third reference signal.

Aspect 8: The method of any of aspects 1 through 7, further comprising: identifying an anchor TRP from the plurality of TRPs based at least in part on the first beam configuration of the plurality of beam configurations, a beam configuration with a lowest index, a third indication of the anchor TRP included in a configuration of the plurality of beam configurations, a fourth indication in a MAC control element, a fifth indication to refrain from using a parameter of the beam configuration, or any combination thereof.

Aspect 9: The method of any of aspects 1 through 8, further comprising: determining an average delay and a delay spread based at least in part on determining whether one or more TRPs of the plurality of TRPs are implementing the pre-compensation scheme and the one or more reference signals.

Aspect 10: The method of any of aspects 1 through 9, further comprising: determining a Doppler shift and a Doppler spread from a reference signal of an anchor TRP based at least in part on determining whether one or more TRPs of the plurality of TRPs are implementing the pre-compensation scheme and the one or more reference signals.

Aspect 11: The method of any of aspects 1 through 10, wherein receiving the first indication comprises: receiving a RRC message comprising the first indication, the first indication comprising a higher layer parameter.

Aspect 12: The method of aspect 11, wherein the higher layer parameter indicates a single frequency network downlink transmission from the plurality of TRPs associated with the plurality of beam configurations.

Aspect 13: The method of aspect 12, wherein the higher layer parameter is configured as part of a physical downlink shared channel higher layer configuration, a physical downlink control channel control resource set configuration, or a combination thereof.

Aspect 14: The method of any of aspects 11 through 13, wherein the higher layer parameter indicates a transmission scheme associated with the reference signal configuration.

Aspect 15: The method of any of aspects 11 through 14, further comprising: determining a reference signal mode based at least in part on receiving the first indication, wherein the reference signal mode comprises a distributed tracking reference signal mode or a partially distributed tracking reference signal mode.

Aspect 16: The method of any of aspects 1 through 15, wherein the plurality of beam configurations comprise a plurality of TCI states.

Aspect 17: The method of any of aspects 1 through 16, further comprising: determining one or more QCL parameters based at least in part on receiving the one or more reference signals; and receiving a downlink message from the first TRP and the second TRP using the determined one or more QCL parameters.

Aspect 18: A method for wireless communications at a base station, comprising: transmitting, to a UE, a first indication that one or more reference signals correspond to a plurality of beam configurations, the UE configured to communicate with a plurality of TRPs; determining whether to use a pre-compensation scheme to communicate with the UE using the plurality of TRPs; transmitting a second indication of a first QCL type and a second QCL type based at least in part on determining whether the pre-compensation scheme is to be used, the first QCL type associated with a first beam configuration corresponding to a first TRP of the plurality of TRPs, and the second QCL type associated with a second beam configuration corresponding to a second TRP of the plurality of TRPs; and transmitting the one or more reference signals according to the first QCL type and the second QCL type.

Aspect 19: The method of aspect 18, further comprising: determining to implement the pre-compensation scheme, wherein the second indication indicates that the first QCL type being different from the second QCL type based at least in part on the pre-compensation scheme being different.

Aspect 20: The method of aspect 19, wherein the first QCL type corresponds to an average delay and a delay spread and the second QCL type corresponds to the average delay, the delay spread, a Doppler shift, and a Doppler spread, further comprising: transmitting a first reference signal from the first TRP different from a second reference signal from the second TRP; and transmitting a downlink message in accordance with the pre-compensation scheme based at least in part on transmitting the first reference signal.

Aspect 21: The method of any of aspects 19 through 20, wherein the first QCL type corresponds to an average delay and a delay spread and the second QCL type corresponds to a Doppler shift and a Doppler spread, further comprising: transmitting a first reference signal; and transmitting a downlink message in accordance with the pre-compensation scheme based at least in part on transmitting the first reference signal.

Aspect 22: The method of any of aspects 19 through 21, wherein the first QCL type corresponds to a delay spread and the second QCL type corresponds to an average delay, the delay spread, a Doppler shift, and a Doppler spread, further comprising: transmitting a first reference signal different from a second reference signal from the second TRP; and transmitting a downlink message in accordance with the pre-compensation scheme based at least in part on transmitting the first reference signal and the second reference signal.

Aspect 23: The method of aspect 18, wherein the first QCL type is a same QCL type as the second QCL type, further comprising: transmitting a first reference signal from the first TRP different from a second reference signal from the second TRP; transmitting, via a set of resources, a downlink message to the UE based at least in part on transmitting the first reference signal.

Aspect 24: The method of any of aspects 18 through 23, wherein the TRP comprises an anchor TRP, further comprising: transmitting, to the UE, a third indication of the anchor TRP included in a configuration of the plurality of beam configurations, a fourth indication in a medium access control (MAC) control element command message, a fifth indication to refrain from using a parameter of a beam configuration, or any combination thereof.

Aspect 25: An apparatus for wireless communications at a UE, comprising a processor; memory coupled with the processor; and instructions stored in the memory and executable by the processor to cause the apparatus to perform a method of any of aspects 1 through 17.

Aspect 26: An apparatus for wireless communications at a UE, comprising at least one means for performing a method of any of aspects 1 through 17.

Aspect 27: A non-transitory computer-readable medium storing code for wireless communications at a UE, the code comprising instructions executable by a processor to perform a method of any of aspects 1 through 17.

Aspect 28: An apparatus for wireless communications at a base station, comprising a processor; memory coupled with the processor; and instructions stored in the memory and executable by the processor to cause the apparatus to perform a method of any of aspects 18 through 24.

Aspect 29: An apparatus for wireless communications at a base station, comprising at least one means for performing a method of any of aspects 18 through 24.

Aspect 30: A non-transitory computer-readable medium storing code for wireless communications at a base station, the code comprising instructions executable by a processor to perform a method of any of aspects 18 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a first indication that one or more reference signals correspond to a plurality of beam configurations, the UE configured to communicate with a plurality of transmission reception points;
receiving a second indication of a first quasi co-location type and a second quasi co-location type based at least in part on receiving the first indication, the first quasi co-location type associated with a first beam configuration, and the second quasi co-location type associated with a second beam configuration; and
receiving the one or more reference signals from the plurality of transmission reception points based at least in part on determining that the plurality of transmission reception points are using a pre-compensation scheme in accordance with the first quasi co-location type and the second quasi co-location type.

2. The method of claim 1, further comprising:
determining that one or more transmission reception points of the plurality of transmission reception points are implementing the pre-compensation scheme based at least in part on the first quasi co-location type being different from the second quasi co-location type, the plurality of transmission reception points comprising at least a first transmission reception point and a second transmission reception point.

3. The method of claim 2, wherein the first quasi co-location type corresponds to an average delay and a delay spread and the second quasi co-location type corresponds to the average delay, the delay spread, a Doppler shift, and a Doppler spread, further comprising:
receiving a first reference signal from the first transmission reception point and a second reference signal from the second transmission reception point; and
receiving a downlink message from the first transmission reception point and the second transmission reception point in accordance with the pre-compensation scheme based at least in part on receiving the first reference signal and the second reference signal.

4. The method of claim 2, wherein the first quasi co-location type corresponds to an average delay and a delay spread and the second quasi co-location type corresponds to a Doppler shift and a Doppler spread, further comprising:
receiving a first reference signal from the first transmission reception point and the first reference signal from the second transmission reception point;
receiving a second reference signal from the first transmission reception point or the second transmission reception point; and
receiving a downlink message from the first transmission reception point and the second transmission reception point in accordance with the pre-compensation scheme based at least in part on receiving the first reference signal, the second reference signal, or both.

5. The method of claim 2, wherein the first quasi co-location type corresponds to a delay spread and the second quasi co-location type corresponds to an average delay, the delay spread, a Doppler shift, and a Doppler spread, further comprising:
receiving a first reference signal from the first transmission reception point and a second reference signal from the second transmission reception point; and
receiving a downlink message from the first transmission reception point and the second transmission reception point in accordance with the pre-compensation scheme based at least in part on receiving the first reference signal and the second reference signal.

6. The method of claim 1, wherein the first quasi co-location type is a same quasi co-location type as the second quasi co-location type, and the plurality of transmission reception points comprise at least a first transmission reception point and a second transmission reception point, further comprising:
receiving a first reference signal from the first transmission reception point and a second reference signal from the second transmission reception point;
receiving, via a set of resources, a downlink message from the first transmission reception point based at least in part on the first reference signal; and
receiving, via the set of resources, the downlink message from the second transmission reception point based at least in part on the second reference signal.

7. The method of claim 6, further comprising:
receiving a third reference signal from the first transmission reception point and the second transmission reception point, the downlink message received further based at least in part on the third reference signal.

8. The method of claim 1, further comprising:
identifying an anchor transmission reception point from the plurality of transmission reception points based at least in part on the first beam configuration of the plurality of beam configurations, a beam configuration with a lowest index, a third indication of the anchor transmission reception point included in a configuration of the plurality of beam configurations, a fourth indication in a medium access control (MAC) control element, a fifth indication to refrain from using a parameter of the beam configuration, or any combination thereof.

9. The method of claim 1, further comprising:
determining an average delay and a delay spread based at least in part on determining whether one or more transmission reception points of the plurality of transmission reception points are implementing the pre-compensation scheme and the one or more reference signals.

10. The method of claim 1, further comprising:
determining a Doppler shift and a Doppler spread from a reference signal of an anchor transmission reception point based at least in part on determining whether one or more transmission reception points of the plurality of transmission reception points are implementing the pre-compensation scheme and the one or more reference signals.

11. The method of claim 1, wherein receiving the first indication comprises:
receiving a radio resource control message comprising the first indication, the first indication comprising a higher layer parameter.

12. The method of claim 11, wherein the higher layer parameter indicates a single frequency network downlink transmission associated with the plurality of beam configurations.

13. The method of claim 12, wherein the higher layer parameter is configured as part of a physical downlink shared channel higher layer configuration, a physical downlink control channel control resource set configuration, or a combination thereof.

14. The method of claim 11, wherein the higher layer parameter indicates a transmission scheme associated with a reference signal configuration.

15. The method of claim 11, further comprising:
determining a reference signal mode based at least in part on receiving the first indication, wherein the reference signal mode comprises a distributed tracking reference signal mode or a partially distributed tracking reference signal mode.

16. The method of claim 1, wherein the plurality of beam configurations comprise a plurality of transmission configuration indicator states.

17. The method of claim 1, wherein the first quasi co-location type corresponds to an average delay and a delay spread and the second quasi co-location type corresponds to the average delay, the delay spread, a Doppler shift, and a Doppler spread.

18. A method for wireless communications at a base station, comprising:
transmitting, to a user equipment (UE), a first indication that one or more reference signals correspond to a plurality of beam configurations, the UE configured to communicate with a plurality of transmission reception points;
transmitting a second indication of a first quasi co-location type and a second quasi co-location type based at least in part on a pre-compensation scheme to be used to communicate with the UE using the plurality of transmission reception points, the second indication identifying a first beam configuration and a second beam configuration of the plurality of beam configurations, the first quasi co-location type associated with a first beam configuration, and the second quasi co-location type associated with a second beam configuration; and
transmitting the one or more reference signals according to the first quasi co-location type and the second quasi co-location type.

19. The method of claim 18, further comprising:
determining to implement the pre-compensation scheme, wherein the second indication indicates that the first quasi co-location type being different from the second quasi co-location type based at least in part on the pre-compensation scheme being different, the plurality of transmission reception points comprising at least a first transmission reception point and a second transmission reception point.

20. The method of claim 19, wherein the first quasi co-location type corresponds to an average delay and a delay spread and the second quasi co-location type corresponds to the average delay, the delay spread, a Doppler shift, and a Doppler spread, further comprising:
transmitting a first reference signal from the first transmission reception point different from a second reference signal from the second transmission reception point; and
transmitting a downlink message in accordance with the pre-compensation scheme based at least in part on transmitting the first reference signal.

21. The method of claim 19, wherein the first quasi co-location type corresponds to an average delay and a delay spread and the second quasi co-location type corresponds to a Doppler shift and a Doppler spread, further comprising:
transmitting a first reference signal; and
transmitting a downlink message in accordance with the pre-compensation scheme based at least in part on transmitting the first reference signal.

22. The method of claim 19, wherein the first quasi co-location type corresponds to a delay spread and the second quasi co-location type corresponds to an average delay, the delay spread, a Doppler shift, and a Doppler spread, further comprising:
transmitting a first reference signal different from a second reference signal from the second transmission reception point; and
transmitting a downlink message in accordance with the pre-compensation scheme based at least in part on transmitting the first reference signal and the second reference signal.

23. The method of claim 18, wherein the first quasi co-location type is a same quasi co-location type as the second quasi co-location type, and the plurality of transmission reception points comprise at least a first transmission reception point and a second transmission reception point, further comprising:
transmitting a first reference signal from the first transmission reception point different from a second reference signal from the second transmission reception point; and
transmitting, via a set of resources, a downlink message to the UE based at least in part on transmitting the first reference signal.

24. The method of claim 18, wherein the transmission reception point comprises an anchor transmission reception point, further comprising:
transmitting, to the UE, a third indication of the anchor transmission reception point included in a configuration of the plurality of beam configurations, a fourth indication in a medium access control (MAC) control element command message, a fifth indication to refrain from using a parameter of a beam configuration, or any combination thereof.

25. An apparatus for wireless communications at a user equipment (UE), comprising:
a processor;
memory coupled with the processor; and
instructions stored in the memory and executable by the processor to cause the apparatus to:
receive a first indication that one or more reference signals correspond to a plurality of beam configurations, the UE configured to communicate with a plurality of transmission reception points;
receive a second indication of a first quasi co-location type and a second quasi co-location type based at least in part on receiving the first indication, the first quasi co-location type associated with a first beam configuration corresponding to a first transmission reception point of the plurality of transmission reception points, and the second quasi co-location type associated with a second beam configuration corresponding to a second transmission reception point of the plurality of transmission reception points; and
receive the one or more reference signals from the plurality of transmission reception points based at least in part on determining that the plurality of transmission reception points are using a pre-compensation scheme in accordance with the first quasi co-location type and the second quasi co-location type.

26. The apparatus of claim 25, wherein the instructions are further executable by the processor to cause the apparatus to:
determine that one or more transmission reception points of the plurality of transmission reception points are implementing the pre-compensation scheme based at least in part on the first quasi co-location type being different from the second quasi co-location type.

27. The apparatus of claim 26, wherein the first quasi co-location type corresponds to an average delay and a delay spread and the second quasi co-location type corresponds to the average delay, the delay spread, a Doppler shift, and a Doppler spread, and wherein the instructions are further executable by the processor to cause the apparatus to:
receive a first reference signal from the first transmission reception point and a second reference signal from the second transmission reception point; and
receive a downlink message from the first transmission reception point and the second transmission reception point in accordance with the pre-compensation scheme based at least in part on receiving the first reference signal and the second reference signal.

28. The apparatus of claim 26, wherein the first quasi co-location type corresponds to an average delay and a delay spread and the second quasi co-location type corresponds to a Doppler shift and a Doppler spread, and wherein the instructions are further executable by the processor to cause the apparatus to:
receive a first reference signal from the first transmission reception point and the first reference signal from the second transmission reception point;
receive a second reference signal from the first transmission reception point or the second transmission reception point; and
receive a downlink message from the first transmission reception point and the second transmission reception point in accordance with the pre-compensation scheme based at least in part on receiving the first reference signal, the second reference signal, or both.

29. An apparatus for wireless communications at a base station, comprising:
a processor;
memory coupled with the processor; and
instructions stored in the memory and executable by the processor to cause the apparatus to:
transmit, to a user equipment (UE), a first indication that one or more reference signals correspond to a plurality of beam configurations, the UE configured to communicate with a plurality of transmission reception points;
transmit a second indication of a first quasi co-location type and a second quasi co-location type based at least in part on a pre-compensation scheme to be used to communicate with the UE using the plurality of transmission reception points, the second indication identifying a first beam configuration and a second beam configuration of the plurality of beam configurations, the first quasi co-location type associated with a first beam configuration, and the second quasi co-location type associated with a second beam configuration; and
transmit the one or more reference signals according to the first quasi co-location type and the second quasi co-location type.

30. The apparatus of claim 29, wherein the instructions are further executable by the processor to cause the apparatus to:
determine to implement the pre-compensation scheme, wherein the second indication indicates that the first quasi co-location type being different from the second quasi co-location type based at least in part on the pre-compensation scheme being different.
